(19) United States
(12) Patent Application Publication
(10) Pub. No.: US 2020/0205399 A1
(43) Pub. Date: Jul. 2, 2020

(54) COMPOSITION FOR CRYOPRESERVATION, METHOD FOR PRODUCING CRYOPRESERVED MATERIAL, CELL PREPARATION, METHOD FOR PRODUCING CELL PREPARATION, AND KIT FOR CRYOPRESERVATION

(71) Applicant: TWO CELLS Co., Ltd., Hiroshima (JP)

(72) Inventors: Jin Chang SHAO, Hiroshima (JP); Shunsuke TANIGAWA, Hiroshima (JP); Masanori NAKASA, Hiroshima (JP); Yukio KATO, Hiroshima (JP); Koichiro TSUJI, Hiroshima (JP); Akihiro OHISO, Hiroshima (JP)

(21) Appl. No.: 16/634,820

(22) PCT Filed: Jul. 31, 2018
(86) PCT No.: PCT/JP2018/028677

§ 371 Date: Jan. 28, 2020

(30) Foreign Application Priority Data
Jul. 31, 2017 (JP) 2017-148607

(51) Int. Cl. A01N 1/02

(52) U.S. Cl. CPC A01N 1/0221; A01N 1/0284

(57) ABSTRACT

An object is to achieve cryopreservation that yields no or few dead cells and that ensures good quality. A composition for cryopreservation in accordance with an aspect of the present invention is a composition for cryopreservation of cells, and contains a fatty acid.

### TECHNICAL FIELD

The present invention relates to compositions for cryopreservation, methods of producing a cryopreserved material, cell preparations, methods of producing a cell preparation, and kits for cryopreservation.

### BACKGROUND ART

Patent Literature 1 discloses that a scaffold-based cell preparation in a frozen state can be obtained by employing, as a scaffold, a specific form of nanofiber or collagen sheet containing specific amounts of specific constituents.

Patent Literature 2 discloses a cell therapeutic agent in the form of a cell suspension. The cell therapeutic agent is provided in a cryopreserved form obtained with a cryopreservation medium having autoserum, and DMSO added thereto.

### CITATION LIST

### Patent Literature

### [Patent Literature 1]

Japanese Patent Application Publication Tokukai No. 2015-198604

### [Patent Literature 2]

Japanese Patent Application Publication Tokukai No. 2009-107929

### SUMMARY OF INVENTION

### Technical Problem

Culture media, agents, and the like for use in production of regenerative medicine products are required to (i) be made of chemically defined constituents, (ii) minimize risks of biological contamination, contamination with immunogenic substances, and the like, and (iii) minimize the amounts of substances that are not present in the body. In order to meet such requirements, the Applicant developed a serum-free, chemically-defined STK (registered trademark) culture medium.

In industrializing a regenerative medicine product, central allogeneic regenerative medicine is important. In the central allogeneic regenerative medicine, cells or the like from a donor who is a different person from patients are cultured and processed into preparations centrally at a plant or a factory, and the preparations are administered to the patients. If cryopreservation is not available here, it will be impossible to keep products in storage; this is very disadvantageous in terms of cost and production control. Under such circumstances, there is a demand for a cryopreservation technique that yields less dead cells even after thawing, and that ensures good quality.

An aspect of the present invention was made in view of the above circumstances, and an object thereof is to provide compositions for cryopreservation that yield less dead cells, and that achieve cryopreservation with good quality.

### Solution to Problem

In order to attain the above object, a composition for cryopreservation in accordance with one aspect of the present invention is a composition for cryopreservation of cells, the composition containing a fatty acid.

A composition for cryopreservation composition in accordance with another aspect of the present invention is a composition for cryopreservation of cells, in which: the cells may be in the form of a three-dimensional cell mass; the composition may be arranged for cryopreservation of the cell mass; and the composition contains at least one constituent selected from the group consisting of fatty acids and fatty acid esters.

A method of producing a cryopreserved material in accordance with a further aspect of the present invention is a method of producing a cryopreserved material obtained by freezing cells, the method including the following steps (a) and (c), the step (c) being carried out after the step (a):

(a) immersing the cells in a cryopreservation medium that contains a fatty acid;

(c) freezing the cells.

A method of producing a cryopreserved material in accordance with still a further aspect of the present invention is a method of producing a cryopreserved material obtained by freezing cells, the cells being in the form of a three-dimensional cell mass, the method including the following steps (a) and (c), the step (c) being carried out after the step (a):

(a) immersing the cells in a cryopreservation medium that contains at least one constituent selected from the group consisting of fatty acids and fatty acid esters;

(c) freezing the cells.

A cell preparation in accordance with still a further aspect of the present invention contains: cells; and a composition for cryopreservation containing a fatty acid, the cell preparation being in a cryopreserved state.

A cell preparation in accordance with still a further aspect of the present invention contains: cells; and a composition for cryopreservation containing at least one constituent selected from the group consisting of fatty acids and fatty acid esters, in which the cells may be in the form of a three-dimensional cell mass, and the cell preparation is in a cryopreserved state.

A method of producing a cell preparation in accordance with still a further aspect of the present invention is a method of producing a cell preparation that contains cells, in which the cells may be in the form of a three-dimensional cell mass, and the method includes the following steps (a) and (c), the step (c) being carried out after the step (a):

(a) immersing the cells in a cryopreservation medium that contains a fatty acid;

(c) freezing the cells.

A method of producing a cell preparation in accordance with still a further aspect of the present invention is a method of producing a cell preparation that contains cells, the method including the following steps (a) and (c), the step (c) being carried out after the step (a):

(a) immersing the cells in a cryopreservation medium that contains at least one constituent selected from the group consisting of fatty acids and fatty acid esters;

(c) freezing the cells.

A kit for cryopreservation in accordance with still a further aspect of the present invention is a kit for cryopreservation of cells, the kit including a fatty acid.

A kit for cryopreservation in accordance with still a further aspect of the present invention is a kit for cryopreservation of cells, the cells being in the form of a three-dimensional cell mass, the kit including at least one constituent selected from the group consisting of fatty acids and fatty acid esters.

### Advantageous Effects of Invention

An aspect of the present invention provides the effect of achieving cryopreservation that yields less dead cells even after thawing, and that ensures good quality.

### BRIEF DESCRIPTION OF DRAWINGS

FIG. 1 shows the results of experimental cryopreservation of mesenchymal stem cells (hereinafter may be referred to as “MSCs”) in the form of a cell suspension. (a) of FIG. 1 schematically shows the kinds of constituents of each cryopreservation medium for comparison purposes. (b) of FIG. 1 shows the results of experimental cryopreservation.

FIG. 2 shows the results of experimental cryopreservation of MSCs in the form of a cell suspension.

FIG. 3 shows the results of experimental cryopreservation of MSCs in the form of a cell suspension.

FIG. 4 shows the results of experimental cryopreservation of MSCs in the form of a cell suspension.

FIG. 5 shows the results of experimental cryopreservation using gMSC (registered trademark) 1.

FIG. 6 shows the results of experiments to check osteocyte differentiation ability and adipocyte differentiation ability of cells after cryopreservation and thawing of gMSC (registered trademark) 1. (a) of FIG. 6 shows the results on osteocyte differentiation ability, and (b) of FIG. 6 shows the results on adipocyte differentiation ability.

FIG. 7 shows the results of experiments to check chondrocyte differentiation ability of cells after shredding gMSC (registered trademark) 1 after cryopreservation and thawing of the gMSC (registered trademark) 1. (a) of FIG. 7 shows photos of samples whose chondrocyte differentiation ability was tested, and (b) of FIG. 7 shows the results of sulfated glycosaminoglycan (glycosaminoglycan: GAG) assay.

FIG. 8 shows the results of experiments to check the expression of a cell surface antigen marker on cells isolated from cryopreserved and thawed gMSC (registered trademark) 1.

FIG. 9 is a bar chart showing the results of Example 3 (gMSC (registered trademark) 1).

FIG. 10 is a bar chart showing the results of experimental cryopreservation of gMSC (registered trademark) 1.

FIG. 11 is a bar chart showing the results of experimental cryopreservation of gMSC (registered trademark) 1.

FIG. 12 is a bar chart showing the results of experimental cryopreservation of gMSC (registered trademark) 1.

FIG. 13 is a bar chart showing the results of experimental cryopreservation of gMSC (registered trademark) 1.

FIG. 14 is a bar chart showing the results of experimental cryopreservation of gMSC (registered trademark) 1.

FIG. 15 is a bar chart showing the results of experimental cryopreservation of gMSC (registered trademark) 1.

### DESCRIPTION OF EMBODIMENTS

The following description will discuss embodiments of the present invention. Note, however, that the present invention is not limited to these embodiments. Note that the numerical ranges “A to B” herein each mean “not less than A and not more than B”, unless otherwise noted herein.

[Composition for Cryopreservation]

A composition for cryopreservation in accordance with an aspect of the present invention is a composition for cryopreservation of cells, and contains at least one fatty acid. A composition for cryopreservation in accordance with another aspect of the present invention is a composition for cryopreservation of cells, in which the cells may be in the form of a three-dimensional cell mass, in which the composition is arranged for cryopreservation of the cell mass, and in which the composition contains at least one constituent selected from the group consisting of fatty acids and fatty acid esters. Hereinafter, the scope of the meaning of the term “composition for cryopreservation” includes both the “composition for cryopreservation of cells” and the “composition for cryopreservation of cells, in which the cells are in the form of a three-dimensional cell mass and in which the composition is arranged for cryopreservation of the cell mass”. For example, a “composition for cryopreservation in accordance with an aspect of the present invention” can be a composition for cryopreservation of cells in the form of a cell suspension or a composition for cryopreservation of cells in the form of a three-dimensional cell mass. Note that the descriptions herein are based on the assumption that the cells are mesenchymal stem cells (described later), which are mere examples. The cells subjected to cryopreservation are not limited to mesenchymal cells.

The inventors found that, with the use of a fatty-acid-containing composition for cryopreservation, cells such as mesenchymal stem cells are frozen in good condition with good recovery rate and good cell viability, and that a sufficient number of cells are preserved even after cryopreservation and thawing. The inventors also found that, with use of a composition for cryopreservation containing at least one constituent selected from the group consisting of fatty acids and fatty acid esters, cells in the form of a three-dimensional cell mass are frozen in good condition with good recovery rate and good cell viability, and that the recovery rate and cell viability after cryopreservation and thawing are also good. Note that the “recovery rate” is the ratio of the total number of cells (including living and dead cells) to the number of cells before the cryopreservation and thawing. The “total number of cells” herein means the number of cells recovered without, for example, being broken or flown out during the cryopreservation and thawing. The “cell viability” is the proportion of the number of living cells to the total number of cells recovered after the cryopreservation and thawing.

The inventors also confirmed that qualities (e.g., three-dimensional differentiation, reaction to marker) of thawed cells were also normal. That is, the inventors confirmed that the properties of the cells remain unchanged even after cryopreservation and thawing. Furthermore, a composition for cryopreservation in accordance with an aspect of the present invention is capable of suitably cryopreserving cells without having to use constituents that are not present in animal cells, such as trehalose, polyethylene glycol, and polylysine, and without having to use serum that has a risk of biotic contamination and that differs greatly from one batch to another. The composition for cryopreservation is, therefore, also excellent in safety and quality.

As used herein, the term “cryopreservation” means freezing cells and preserving the frozen cells. Specifically, the term “cryopreservation” means preserving cells by subjecting the cells to extremely low temperatures such as, preferably, a temperature equal to or below −80° C.

(Cells)

Examples of cells to be frozen with use of a composition for cryopreservation in accordance with an aspect of the present invention include: mesenchymal stem cells, CD34 cells, embryonic stem cells (ES cells), iPS cells (induced pluripotent stem cells), cartilage cells (chondrocytes), osteoblastic cells (osteoblasts), fibroblastic cells (fibroblasts), epidermal cells (keratinocytes), epithelial cells (epitheliocytes), adipose cells (adipocytes), hepatic cells (hepatocytes), pancreatic cells, muscle cells (myocytes), nerve cells (neurocytes), neural stem cells, hematopoietic stem cells, and precursors to such cells. The cells may be those which are positive for a marker of interest. There is no particular limitation on a biological species from which the cells are derived. Examples of the biological species include microorganisms, non-human mammals, and humans.

The above-described cells can be obtained by culture using a known method. A culture medium for use in culture of the cells is selected appropriately according to the cells to be cultured. A culture vessel suitable for proliferation of cells is also selected appropriately according to the cells to be cultured. The descriptions in this (Cells) section also apply to cells for use in other aspects of the present invention described later (i.e., a method of producing a cryopreserved material, a cell preparation, a method of producing a cell preparation, and a kit for cryopreservation).

(Mesenchymal Stem Cells)

The following description discusses mesenchymal stem cells (hereinafter may be referred to as MSCs), which are an example of cells to be frozen with use of a composition for cryopreservation in accordance with an aspect of the present invention. The mesenchymal stem cells are advantageous in that they have the ability to differentiate into cells belonging to the mesenchymal lineage and also have immunosuppressive action, and therefore are considered one of the most promising cells in regenerative medicine.

As used herein, the term “mesenchymal stem cells” refers to somatic stem cells that differentiate into tissues belonging to the mesenchymal lineage. The scope of the meaning of the term “mesenchymal stem cells” also includes: cells having a specific property which have been isolated from mesenchymal stem cells; mesenchymal stem cells which have been subjected to some stimulation such as cytokine stimulation; and mesenchymal stem cells with some gene introduced. For example, the scope of the meaning of the term “mesenchymal stem cells” also includes MUSE cells, MAPC cells, SP-1 cells, and the like. The mesenchymal stem cells have a proliferating ability and have the ability to differentiate into bone cells (osteocytes), cartilage cells (chondrocytes), muscle cells (myocytes), stromal cells, tendon cells (tenocytes), adipose cells (adipocytes), and the like. The scope of the meaning of the term “mesenchymal stem cells” includes, for example, not only those isolated from various cells or the like of adult tissues such as bone marrow, adipose cells (adipocytes), synovial cells (synoviocytes), alveolar bone, and periodontal membrane, but also those isolated from various cells or the like of placenta, umbilical cord, umbilical cord blood, and a fetus. The mesenchymal stem cells are preferably human mesenchymal stem cells, but may be mesenchymal stem cells derived from a non-human animal such as a rat or a mouse.

The mesenchymal stem cells can be obtained by culture using a known method. The mesenchymal stem cells are preferably those obtained in serum-free culture conditions or low serum culture conditions. The mesenchymal stem cells are more preferably those obtained in serum-free culture conditions. The constituents used in serum-free culture are all chemically defined. That is, serum is naturally derived and therefore differs in constituents from one batch to another, whereas a serum-free culture medium does not show such differences. Therefore, mesenchymal stem cells obtained in serum-free culture conditions are excellent in safety and quality. It is also possible to minimize the risk of biological contamination, the risk of contamination with immunogenic substances, and the like risks, and also possible to minimize the amounts of substances that are not present in the body. Furthermore, biological materials contained in a serum-free culture medium are clearly defined, and therefore quality control is easy.

Furthermore, mesenchymal stem cells cultured in serum-free culture conditions in some kind of serum-free culture medium, such as an STK (registered trademark) culture medium, show high proliferation rate. According to an aspect of a cryopreservation method and an aspect of a cell preparation in accordance with the present invention, cells obtained by culture in the foregoing serum-free culture conditions are subjected to freezing. Therefore, even after some cycles of subculture, the cells are in fresh conditions showing no senescence such as occurrence of pseudopodia or changes into flattened cells. Because such mesenchymal stem cells in good condition are subjected to freezing, the mesenchymal stem cells can be cultured with high proliferation rate and used even after cryopreservation and thawing.

As used herein, the term “serum-free culture” is intended to mean culture using no serum. For example, the “serum-free culture” is intended to mean culture using a serum-free culture medium, which is a culture medium that contains no serum. The term “low serum culture” is intended to mean (i) culture using a culture medium that contains less serum than a typical serum-containing culture medium (e.g., 10% FBS-containing culture medium) and/or (ii) culture in which a serum-containing culture medium is used for a shorter period of time than typical culture using a serum-containing culture medium.

(Example of Serum-Free Culture)

First, the following discusses an example of a serum-free culture medium for use in serum-free culture of cells that are to be frozen with use of a composition for cryopreservation in accordance with an aspect of the present invention. A basal medium for a serum-free culture medium is not particularly limited, provided that the basal medium is a culture medium for animal cells known in this field. Preferred examples of the basal medium include Ham's F12 culture media, DMEM culture media, RPMI-1640 culture media, and MCDB culture media. One of such basal media may be used alone, or a mixture of two or more of them may be used. In one embodiment, the basal medium for the serum-free culture medium is preferably a culture medium which is a mixture of MCDB and DMEM mixed at a ratio of 1:1.

In one embodiment, a serum-free culture medium obtained by adding an FGF, a PDGF, a TGF-β, an HGF, an EGF, at least one phospholipid, and at least one fatty acid to any of the foregoing basal media may be used in a proliferation step. The FGF is added to the basal medium in an amount to achieve a final concentration of preferably 0.1 to 100 ng/ml, more preferably 3 ng/ml. The PDGF is added to the basal medium in an amount to achieve a final concentration of preferably 0.5 to 100 ng/ml, more preferably 10 ng/ml. The TGF-β is added to the basal medium in an amount to achieve a final concentration of preferably 0.5 to 100 ng/ml, more preferably 10 ng/ml.

The HGF is added to the basal medium in an amount to achieve a final concentration of preferably 0.1 to 50 ng/ml, more preferably 5 ng/ml. The EGF is added to the basal medium in an amount to achieve a final concentration of preferably 0.5 to 200 ng/ml, more preferably 20 ng/ml. The at least one phospholipid is added to the basal medium in an amount, in total, to achieve a final concentration of preferably 0.1 to 30 μg/ml, more preferably 10 μg/ml. The total amount of the at least one fatty acid relative to the basal medium is preferably 1/1000 to 1/10, more preferably 1/100.

The use of such a serum-free culture medium has a proliferation promoting effect, which is equivalent to or better than that of a serum-containing medium, while preventing hetero protein contamination. This makes it possible to proliferate mesenchymal stem cells desirably.

The serum-free culture medium may contain at least one phospholipid. Examples of the phospholipid include phosphatidic acid, lysophosphatidic acid, phosphatidylinositol, phosphatidylserine, phosphatidylethanolamine, phosphatidylcholine, and phosphatidylglycerol. One of such phospholipids may be used alone, or two or more of such phospholipids may be used in combination. In one embodiment, the serum-free culture medium may contain phosphatidic acid and phosphatidylcholine in combination, and these phospholipids may be derived from animals or plants.

The serum-free culture medium may contain at least one fatty acid. Examples of the fatty acid include linoleic acid, oleic acid, linolenic acid, arachidonic acid, myristic acid, palmitoleic acid, palmitic acid, and stearic acid. Additives for a culture medium in accordance with the present embodiment may contain any one of such fatty acids alone or two or more of such fatty acids in combination. Further, the serum-free culture medium in accordance with the present embodiment may contain not only the fatty acid(s) but also cholesterol.

The term “FGF” as used herein means a growth factor selected from a fibroblast growth factor (FGF) family, and is preferably FGF-2 (bFGF). However, other FGFs of the FGF family, such as FGF-1, may also be selected. The term “PDGF” as used herein means a growth factor selected from a platelet derived growth factor (PDGF) family, and is preferably PDGF-BB or PDGF-AB. The term “TGF-β” as used herein means a growth factor selected from a transforming growth factor-β (TGF-β) family, and is preferably TGF-β1. However, other TGF-βs of the TGF-β family may also be selected.

The term “HGF” as used herein means a growth factor selected from a hepatocyte growth factor family, and the term “EGF” as used herein means a growth factor selected from an epidermal growth factor (EGF) family.

In one embodiment, the serum-free culture medium may further contain at least two factors selected from the group consisting of connective tissue growth factors (CTGFs), vascular endothelial growth factors (VEGFs), and ascorbic acid compounds.

The term “ascorbic acid compound” as used herein means ascorbic acid (vitamin C), ascorbic acid-2-phosphate, or a compound similar to any of those listed above.

Note that the growth factors contained in the serum-free culture medium may be naturally-occurring ones or may be ones produced by gene modification.

In one aspect, the serum-free culture medium preferably contains a lipid antioxidant. The lipid antioxidant contained in the serum-free culture medium may be DL-α-tocopherol acetate (vitamin E) in one embodiment. The serum-free culture medium may further contain a surfactant. The surfactant contained in the serum-free culture medium may be Pluronic F-68 or Tween 80 in one embodiment.

The serum-free culture medium may further contain insulin, transferrin, and/or selenate. The term “insulin” as used herein may refer to an insulin-like growth factor, may refer to one derived from a natural cell or may refer to one produced by gene modification. The additives for a culture medium in accordance with the present invention may further contain dexamethasone or some other glucocorticoid.

When carrying out serum-free culture, mesenchymal stem cells isolated from an animal tissue or cell (e.g., human tissue or cell) by a known method is inoculated into the serum-free culture medium described above, and is cultured until the number of mesenchymal stem cells reaches a desired number. Preferred conditions under which the culture is carried out are as follows: 1×10⁴ to 2×10⁴ mesenchymal stem cells are inoculated into a 1 mL medium; culture temperature is 37° C.±1° C.; culture time is in the range of from 48 to 96 hours; and culture environment is under 5% CO₂. By culturing the mesenchymal stem cells under such conditions, it is possible to efficiently produce a large number of mesenchymal stem cells whose immunosuppressive ability is maintained or improved.

A culture vessel for use in culture is not particularly limited, provided that mesenchymal stem cells can be proliferated in the culture vessel. For example, a 75 cm² flask (Falcon), a 75 cm² flask (manufactured by SUMITOMO BAKELITE CO., LTD.), or the like can be suitably used. Note, however, that proliferation of some cells may be affected by a kind of a culture vessel used. It is therefore preferable that, in order to proliferate more efficiently mesenchymal stem cells, the mesenchymal stem cells to be proliferated (hereinafter, also referred to as a “proliferation target cells”) in the proliferation step is subjected to the proliferation step by use of a culture vessel suitable for proliferation of these mesenchymal stem cells.

Examples of a method for selecting a culture vessel suitable for proliferation of proliferation target cells include a method in which an optimum culture vessel is selected by the proliferation target cells. More specifically, multiple kinds of culture vessels are prepared, and proliferation target cells are proliferated under the same condition except the kinds of culture vessels. After two weeks from the start of culture, the number of cells in each vessel is measured by a known method. Then, it can be determined that culture vessels having a greater number of cells are more suitable for proliferation of the proliferation target cells. Further, in a case where the proliferation speed of the proliferation target cells is high, it can be determined, even before two weeks from the start of the culture, that culture vessels in which 80% to 90% confluence has been reached quicker are more suitable for proliferation of the proliferation target cells.

Note that adhesion of the mesenchymal stem cells to a culture vessel is essential in proliferation of the mesenchymal stem cells. It is therefore preferable that, in a case where the proliferation target cells insufficiently adhere to the culture vessel, the serum-free culture medium further contains cell adhesion molecules in a step of serum-free culture. Examples of the cell adhesion molecules include fibronectin, collagen, and gelatin. Each type of these cell adhesion molecules may be used alone, or two or more types of the cell adhesion molecules may be used in combination.

The cell adhesion molecules are added to the serum-free culture medium in an amount to achieve a final concentration of preferably 1 to 50 μg/ml, more preferably 5 μg/ml. In one embodiment, in a case where the cell adhesion molecules are fibronectin, the fibronectin is added so that the final concentration of fibronectin in the serum-free culture medium is 5 μg/ml. This can improve the adhesion efficiency of the proliferation target cells with respect to the culture vessel.

In the serum-free culture, the mesenchymal stem cells may be subcultured at least once. The mesenchymal stem cells are proliferated scaffold-dependently. For example, in a case where the mesenchymal stem cells are locally unevenly proliferated or a like case, the culture condition of the mesenchymal stem cells can be improved by subculturing the mesenchymal stem cells in the process of the proliferation step.

The subculture of the mesenchymal stem cells may be carried out in any way, and may be performed by a known method of subculturing mesenchymal stem cells. For the sake of good cell conditions of subcultured mesenchymal stem cells, it is preferable to detach the mesenchymal stem cells by use of a cell detachment agent which does not contain any constituent derived from mammals and microorganisms, in a case where the mesenchymal stem cells are to be subcultured in the proliferation step. Examples of the “cell detachment agent which does not contain any constituent derived from mammals and microorganisms” include TrypLE Select CTS (Thermo Fisher Scientific Inc.) and ACCUTASE (Innovative Cell Technologies, Inc.).

(Form of the Object to be Cryopreserved)

Cells to be subjected to freezing with use of a composition for cryopreservation in accordance with an aspect of the present invention may be in any form, and may be, for example, a cell suspension, cells cultured in the form of a sheet, a three-dimensional cell mass, or the like. Of these, mesenchymal stem cells in the form of a three-dimensional cell mass are more preferred, and mesenchymal stem cells in the form of a scaffold-free cell mass are even more preferred.

A cell mass is preferably composed only of mesenchymal stem cells. Note, however, that the cell mass may contain collagen and/or a polysaccharide such as hyaluronic acid. In a case where the cell mass contains collagen and/or a polysaccharide such as hyaluronic acid, the amount of the collagen and/or polysaccharide is preferably 0.1 to 50% (v/v) of the cell mass.

A cell mass may be or may not be subjected to a treatment to infiltrate the cell mass with a cryopreservation medium (which is an example of a composition for cryopreservation of the present invention) (such a treatment is referred to as equilibration) before freezing. Particularly in a case where “freezing without medium” (described later, see Table 5) is carried out, it is preferable that the step of equilibration is carried out.

(Three-Dimensional Structure)

According to a composition for cryopreservation in accordance with an aspect of the present invention, it is possible to freeze a three-dimensional cell mass suitably. There have been reports that, in a case where a cell suspension is administered to an affected area, even mesenchymal stem cells, which are said to be immune-privileged when administered, wander off from the affected area, and that the mesenchymal stem cells do not remain in the affected area because, for example, attack by the host's immune cells. In this regard, with the use of a three-dimensional cell mass, it is possible to prevent the cells from wandering off from the affected area or detaching from the affected area, and a long-term therapeutic effect is achieved.

On the contrary, a cell preparation in the form of a three-dimensional structure is far more difficult to cryopreserve than cell preparations in the form of a cell suspension. Moreover, when a cell mass to be frozen is large in size or thickness like a three-dimensional structure, the cell mass is difficult to freeze uniformly throughout it including its inner portions, for heat conduction reasons. In this regard, according to an aspect of the present invention, such a three-dimensional mass can also be cryopreserved in a manner that yields no or few dead cells even after thawing and that causes no or few changes in the properties of the cells even through cryopreservation and thawing. The three-dimensional cell mass may be obtained by processing a cell mass into a three-dimensional structure by a known method. As used herein, the term “three-dimensional structure” with regard to a cell mass refers to a three-dimensionally extending object (i) in which a matrix is disposed three-dimensionally, (ii) in which cells are arranged three-dimensionally, and (iii) which contains cells that maintain bonds between them and the orientations thereof.

The shape of the three-dimensional structure may be selected according to, for example, the purpose of a therapy. For example, the area, thickness, and strength may be selected appropriately according to the area where the structure is grafted. A person skilled in the art can appropriately select the size of the three-dimensional structure. The size can be selected according to the environment in which the structure is grafted. Small cell masses are advantageous in that they can be injected into a body cavity with use of an injection needle, for example. Large cell masses are advantageous in that a sufficient number of cells can be easily administered, because, for examples, the large cell masses are easy to handle. For example, the large cell masses can be easily pinched with forceps during a surgery.

In a case where a three-dimensional structure is grafted, it is preferable that the structure has a certain size or larger. The size is as follows, for example. The three-dimensional structure preferably has an area of not less than 1 cm², preferably not less than 2 cm², more preferably not less than 3 cm². The area is even more preferably not less than 4 cm², not less than 5 cm², not less than 6 cm², not less than 7 cm², not less than 8 cm², not less than 9 cm², not less than 10 cm², not less than 15 cm², or not less than 20 cm², and can be, for example, not more than 40 cm², not more than 30 cm², not more than 20 cm². Note, however, that the area is not limited to those listed above, and can be equal to or less than 1 cm² or equal to or more than 40 cm² depending on the application.

The size in terms of volume is preferably not less than 2 mm³, more preferably not less than 40 mm³, and can be, for example, not more than 40 cm³ or not more than 20 cm³. Note, however, that the volume is not limited to those listed above, and may be equal to or less than 2 mm³.

A sufficient thickness of a graftable artificial tissue varies depending on the area where the tissue is grafted. A person skilled in the art can select the thickness appropriately. The thickness can be selected according to the environment in which the tissue is grafted, and may be more than 5 mm. In a case where the tissue is grafted to the heart, the tissue only needs to have a minimum necessary thickness for grafting to the heart; however, in a case where the tissue is intended for some other purpose, the thickness may be preferably greater. In that case, the thickness is, for example, not less than 2 mm, more preferably not less than 3 mm, even more preferably not less than 5 mm. For example, in a case where the tissue is intended for application to a bone, cartilage, ligament, tendon or the like, the thickness of the tissue can be, as with the case of the heart, for example, not less than 1 mm, preferably not less than 2 mm, more preferably not less than 3 mm, even more preferably not less than 5 mm. In either case, the thickness may be equal to or less than 1 mm, equal to or less than 10 mm, or equal to or less than 5 mm.

The number of cells constituting the cell mass may be selected appropriately. For example, the number of cells constituting the cell mass may be 50 to 200, or may be one million to one hundred million. The mass may be small or large. As described earlier, large cell masses are difficult to freeze uniformly throughout them including their inner portions for heat conduction reasons, and therefore the large cell masses are very difficult to cryopreserve in good condition by known methods. In this regard, according to an aspect of the present invention, even such large cell masses can be cryopreserved in a manner that yields no or few dead cells even after thawing and that causes no or few changes in the properties of the cells even through cryopreservation and thawing.

With use of a three-dimensional cell mass having any of the foregoing example sizes, it is possible to effectively prevent the cells from wandering off from the affected area, and a longer-term therapeutic effect is achieved. Furthermore, with use of a composition for cryopreservation in accordance with an aspect of the present invention, even such large cell masses can be cryopreserved in a manner that yields no or few dead cells even after thawing and that causes no or few changes in the properties of the cells even through cryopreservation and thawing.

(Test on Induction of Differentiation of Cell Mass into Chondrocytes (Cartilage Cells))

A mass of mesenchymal stem cells, when grafted, preferably has not undergone any differentiation induction and is in an undifferentiated state. In a case where the ability of the grafted cell mass to differentiate into chondrocytes (cartilage cells) is evaluated in vitro, the cell mass is preferably cut into small pieces regardless of whether the cell mass has not been cryopreserved or has been cryopreserved and thawed. This is because the cell mass cut in small pieces is more easily infiltrated thoroughly with a differentiation induction culture medium. A means used to cut the cell mass is not particularly limited, and is, for example, a sterile knife or scissors. The cut pieces of the cell mass more preferably have a size of about 10 mg to 20 mg.

(Scaffold Free)

A cell mass to be frozen with use of a composition for cryopreservation in accordance with an aspect of the present invention is preferably a scaffold-free, three-dimensional structure. As used herein, the term “scaffold-free” (framework-free, substrate-material-free) means that the structure contains substantially no material conventionally used to produce an artificial tissue (such a material is a substrate material, or a scaffold).

Existing cell preparations mainly used are “scaffold-type” cell preparations, which are obtained by artificially adding a scaffold (i.e., a material supporting cells and tissues, which allows the cells to adhere or remain on the material and thereby allows the cells to grow) to a cell preparation and thereby processing it into a three-dimensional structure. However, recently, developments are in progress on a “scaffold-free” cell preparation, which is produced by, for example, stimulating cell themselves and allowing them to produce an environment that would serve as a framework for the cells without artificial addition of scaffolds, because of the concerns about the risk of artificial addition of materials. A scaffold-free, three-dimensional cell preparation contains materials other than mesenchymal stem cells in a lesser amount. Furthermore, the scaffold-free, three-dimensional cell preparation achieves the following: constituents thereof are chemically defined; the risk of biological contamination, the risk of contamination with immunogenic substances, and the like risks are minimized; and the amounts of substances that are not present in the body are minimized. For example, a natural product such as collagen is used as a scaffold in some cases. Such a natural product varies in constituents from one batch to another. In this regard, the scaffold-free, three-dimensional cell preparation uses chemically defined constituents, and therefore is excellent in safety and quality stability. In addition, the foregoing natural product has a risk of biological contamination, and may contain immunogenic substances. The scaffold-free, three-dimensional cell preparation can reduce such risks. Recently, development has been conducted on methods of also cryopreserving a three-dimensional cell mass. However, such methods use, as a scaffold, a specific form of nanofiber or collagen sheet containing specific amounts of specific constituents. Therefore, these methods cannot be used for the “scaffold-free” cell preparation in principle. According to an aspect of the present invention, such scaffold-free, three-dimensional cell masses can also be cryopreserved in a manner that yields no or few dead cells even after thawing and that causes no or few changes in the properties of the cells even through freezing and thawing.

A scaffold-free, three-dimensional cell mass that contains mesenchymal stem cells, which is an example of a target to be frozen in the present invention, can be obtained by, for example, a method using a known low attachment plate, a known micropatterned surface plate, or the like or a hanging drop method. Alternatively, the scaffold-free, three-dimensional cell mass may be prepared using a method disclosed in Japanese Patent No. 4522994. Alternatively, a commercially available product may be used. For example, gMSC (registered trademark) 1 (manufactured by TWOCELLS Company Limited) can be suitably used.

(Fatty Acid)

A composition for cryopreservation in accordance with an aspect of the present invention contains a fatty acid. The composition for cryopreservation, which contains a fatty acid, thereby achieves freezing cells with good cell viability, and the properties of cells after thawing are no or little different from what they were before.

Examples of the fatty acid include linoleic acid, oleic acid, linolenic acid, arachidonic acid, myristic acid, palmitoleic acid, palmitic acid, and stearic acid. It is especially preferable that the fatty acid(s) contained in the composition for cryopreservation is/are at least one of linoleic acid and linolenic acid. The composition for cryopreservation, which contains at least one of linoleic acid and linolenic acid, thereby achieves freezing mesenchymal stem cells with a higher cell viability. The fatty acid may be a short-chain fatty acid, a medium-chain fatty acid, or a long-chain fatty acid. The fatty acid may be a polyunsaturated fatty acid. One of such fatty acids may be used alone or a mixture of two or more of them may be used. Especially a mixture of two or more of such fatty acids is preferred. It is more preferable that the kinds and amounts of fatty acids contained in the mixture are chemically defined. For example, it is more preferably to use a Chemically defined lipid concentrate (manufactured by Thermo Fisher Scientific Inc., Product Number: 11905-031) (hereinafter referred to as “CD lipid (registered trademark)”). Note that the kinds and amounts of constituents of an undiluted CD lipid (registered trademark) are as follows.

Arachidonic Acid 2.0 μg/ml,

Cholesterol 220.00 μg/ml,

DL-α-Tocopherol-Acetate 70.00 μg/ml,

Linoleic Acid 540.00 μg/ml,

Linolenic Acid 10.00 μg/ml,

Myristic Acid 10.00 μg/ml,

Oleic Acid 10.00 μg/ml,

Palmitoleic Acid 10.00 μg/ml,

Palmitic Acid 10.00 μg/ml,

Stearic Acid 10.00 μg/ml,

Pluronic F-68 100 mg/ml,

Tween 80 2.2 mg/ml

As described above, any of the fatty acids listed above may be used alone or a mixture of two or more of them may be used, but it is more preferable that a mixture of two or more of them is used. A composition for cryopreservation which contains a mixture of a larger number of kinds of fatty acids achieves freezing mesenchymal stem cells with higher cell viability, and causes no or few changes in properties of cells even through thawing.

The amount of the fatty acid(s) contained in a composition for cryopreservation in accordance with an aspect of the present invention is not particularly limited. For example, it is preferable that the amount of the fatty acid(s) relative to the total amount of the composition for cryopreservation is 0.01 μg/ml to 500 μg/ml (final concentration). For example, it is more preferable that the amount of the fatty acid(s) relative to the total amount of the composition for cryopreservation is 1/1000 to 1/10 (v/v).

In a case where, for example, a CD lipid (registered trademark) is used, it is more preferable that the amount of the CD lipid relative to the total amount of the composition for cryopreservation is 1/1000 to 1/10 (v/v) (PA: 0.5 to 100 μg/ml, PC: 0.5 to 100 μg/ml). A larger amount of the fatty acid(s) is more preferred, provided that the foregoing ranges are satisfied. That is, it is more preferable that the composition for cryopreservation contains a lot of a fatty acid(s), and it is even more preferable that the number of kinds of the fatty acids and the amounts of the fatty acids are both large. This makes it possible to freeze mesenchymal stem cells with a higher cell viability, and the properties of cells after thawing are no or little different from what they were before.

(Fatty Acid Ester)

A composition for cryopreservation in accordance with an aspect of the present invention contains a fatty acid ester. The composition for cryopreservation, which contains a fatty acid ester, thereby achieves freezing cells with good cell viability.

Examples of the fatty acid ester include phospholipids and neutral fats. It is especially preferable that the composition for cryopreservation contains a phospholipid.

Examples of phospholipids include phosphatidic acid (sodium salt of phosphatidic acid is hereinafter referred to as PA, and the scope of the meaning of the term “phosphatidic acid” also includes the salt thereof), lysophosphatidic acid, phosphatidylinositol, phosphatidylserine, phosphatidylethanolamine, phosphatidylcholine (hereinafter referred to as PC), and phosphatidylglycerol.

In a case where the composition for cryopreservation contains a fatty acid ester(s) such as a phospholipid, it is preferable that the amount of the fatty acid ester(s), relative to the total amount of the composition for cryopreservation, is 0.01 μg/ml to 500 μg/ml (final concentration in the composition for cryopreservation when used).

(Surfactant or the Like)

A composition for cryopreservation in accordance with an aspect of the present invention may further contain a substance that helps a fatty acid or a fatty acid ester dissolve in water (emulsify), such as a surfactant. Examples of the surfactant include Pluronic F-68 and Tween 80.

It is preferable that the composition for cryopreservation contains (i) at least one fatty acid and/or at least one fatty acid ester and (ii) a surfactant. For example, the composition for cryopreservation preferably contains phosphatidic acid and Pluronic F-68. With use of such a composition for cryopreservation, it is possible to freeze cells with good cell viability.

(Cryoprotectant Such as DMSO)

The constituents of the foregoing composition for cryopreservation in accordance with an aspect of the present invention may include a cryoprotectant that inhibits the growth of ice crystals within cells during freezing and thawing. The cryoprotectant is, for example, dimethyl sulfoxide (DMSO) or the like. In a case where a composition for cryopreservation in accordance with an aspect of the present invention contains a cryoprotectant, the amount of the cryoprotectant relative to the total amount of the composition for cryopreservation is more preferably 0.5% to 50% (v/v).

(Other Constituents)

A composition for cryopreservation in accordance with an aspect of the resent invention may contain constituent(s) other than fatty acids. Examples of such other constituents include basal media, thickeners, pH adjusters, and cryoprotectants.

It is more preferable that a composition for cryopreservation in accordance with an aspect of the present invention contains insulin, albumin, and/or transferrin. Insulin, albumin, and transferrin enhance the effects of fatty acids. In a case where insulin, albumin, and/or transferrin is/are added to a composition for cryopreservation, such insulin, albumin, and/or transferrin is/are added preferably in an amount to achieve a final concentration of 0.5 μg/ml to 500 μg/ml in a cryopreservation medium when used.

(Method of Producing Composition for Cryopreservation)

A composition for cryopreservation in accordance with an aspect of the present invention can be obtained by merely mixing the foregoing constituents, such as a fatty acid(s), appropriately.

(Product Form)

A composition for cryopreservation in accordance with an aspect of the present invention can be provided in any form. For example, the composition may be in a liquid state, or may be in a solid state such as in the form of powder or a tablet. In a case where the composition is provided in a solid state, a user only needs to dissolve the composition in an appropriate solvent to obtain a cryopreservation medium before use. A composition for cryopreservation in accordance with an aspect of the present invention may be provided together with instructions that specify an appropriate solvent(s).

(Method of Producing Cryopreserved Material)

A cryopreservation method in accordance with an aspect of the present invention is a method of producing a cryopreserved material obtained by freezing cells, and the method includes the following steps (a) and (c), the step (c) being carried out after the step (a):

(a) immersing the cells in a cryopreservation medium that contains a fatty acid;

(c) freezing the cells.

A cryopreservation method in accordance with another aspect of the present invention is a method of producing a cryopreserved material obtained by freezing cells, the cells being in the form of a three-dimensional cell mass, the method including the following steps (a) and (c), the step (c) being carried out after the step (a):

(a) immersing the cells in a cryopreservation medium that contains at least one constituent selected from the group consisting of fatty acids and fatty acid esters;

(c) freezing the cells.

Note that the foregoing descriptions in regard to a composition for cryopreservation in accordance with an aspect of the present invention apply mutatis mutandis to a method of producing a cryopreserved material in accordance with an aspect of the present invention. The following description will mainly discuss differences between the matters related to the composition and matters related to the method. Also note that the term “cryopreserved material” refers to an object in a cryopreserved state.

(Cryopreservation medium) A cryopreservation medium for use in a method of producing a cryopreserved material in accordance with an aspect of the present invention contains at least one constituent selected from the group consisting of fatty acids and fatty acid esters. The cryopreservation medium may be any of the foregoing compositions for cryopreservation in accordance with an aspect of the present invention in a liquid state. With regard to the foregoing compositions for cryopreservation in accordance with an aspect of the present invention in a solid state, a solution obtained by dissolving any of the compositions in a solvent may be used.

(Step (a))

In step (a), cells to be frozen are immersed in a cryopreservation medium that contains a fatty acid. The cells are immersed in the cryopreservation medium preferably by, for example, placing the cryopreservation medium in a vessel that withstands cryopreservation and placing the cells in the cryopreservation medium. This is preferred because the cells in the vessel can be directly subjected to freezing in step (c) (described later).

The volume ratio of the cryopreservation medium to the cells to be frozen, when immersion is carried out, is not particularly limited, provided that cryopreservation is available. For example, the volume of the cryopreservation medium to the cell volume is about 1:1 to 1:1000 (about 50 cells/ml to one hundred million cells/ml). Provided that such a ratio is satisfied, the cells can be thoroughly infiltrated with the cryopreservation medium. Furthermore, in a case where the foregoing three-dimensional cell mass is used, the cell mass can be thoroughly infiltrated with the cryopreservation medium.

(Step (b))

It is more preferable that a method of producing a cryopreserved material in accordance with an aspect of the present invention includes step (b) (step of reducing the amount, relative to the cells, of the cryopreservation medium in which the cells are immersed) after the step (a), and that the cells having been subjected to the step (b) are frozen in step (c). This makes it possible to shorten the time taken for the cryopreserved cells to thaw, and thus possible to further improve the recovery rate of cells after cryopreservation, the total number of cells, and cell viability.

The step (b) may include, specifically, removing a cryopreservation medium from the mesenchymal-stem-cell-containing cryopreservation medium or removing mesenchymal stem cells from the mesenchymal-stem-cell-containing cryopreservation medium. It is more preferable that the step (b) includes bringing the mesenchymal stem cells into a state in which they are not immersed in the cryopreservation medium. This makes it possible to shorten the time taken for the cells to thaw, and thus possible to further improve the recovery rate of cells after cryopreservation, the total number of cells, and cell viability. Note, however, that, even in a case of bringing the mesenchymal stem cells into a state in which they are not immersed in the cryopreservation medium, it is not essential to completely separate the cryopreservation medium from the mesenchymal stem cells. Some amount of the cryopreservation medium may remain in a vessel in which the mesenchymal stem cells are contained. The following arrangement may be employed, for example: the cryopreservation medium is aspirated from a vessel in which the mesenchymal stem cells are immersed in the cryopreservation medium; or the mesenchymal stem cells are removed from the vessel. In a case where the cryopreservation medium is aspirated, the aspiration can be carried out with use of a known aspiration instrument such as a pipette.

(Step (c))

Step (c) includes freezing mesenchymal stem cells. In a case where the step (c) is carried out after the step (b), the step (c) includes freezing mesenchymal stem cells in a state in which they are not immersed in the medium, obtained from the step (b). The temperature at which freezing is carried out may be set as appropriate to a temperature at which the mesenchymal stem cells to be frozen freeze, and is, for example, equal to or below −80° C. or equal to or below −196° C. In a case where freezing is carried out at a temperature equal to or below −80° C., for example, a known method or the like may be used. In a case where freezing is carried out at a temperature equal to or below −196° C., liquid nitrogen may be used.

(Cryopreservation Vessel)

A vessel for use in cryopreservation is not limited, provided that the vessel withstands freezing temperatures. For example, the vessel is preferably one that withstands −80° C., more preferably one that withstands −196° C. Specifically, the vessel is more preferably made of a synthetic resin such as polyethylene, polypropylene, or polyethylene terephthalate. For example, a commercially available cryogenic vial (freezing vessel) may be used as the vessel.

(Method of Recovering Cells)

A method of recovering cells after cryopreservation is not particularly limited. For example, the cryopreserved material may be allowed to thaw. A method of allowing the cryopreserved material to thaw is not limited, provided that the material is allowed to thaw at a temperature at which the cells are not damaged. A known method may be used, examples of which include generally used methods such as a method by which the material is allowed to thaw in a water bath, a method using a heat block, and room-temperature thawing. A method by which the material is allowed to thaw in a water bath, and a method using a heat block, are preferred. Of these, a method by which the material is allowed to thaw in a water bath is more preferred in terms of, for example, the temperature at which thawing is carried out and the time taken for thawing to complete.

The temperature at which thawing is carried out is preferably equal to or above 10° C. and equal to or below 45° C., more preferably equal to or above 20° C. and equal to or below 40° C., even more preferably equal to or above 35° C. and equal to or below 40° C. For example, the material may be allowed to stand at room temperature (25° C.); however, as will be described later in Examples, it is more preferable that the material is allowed to thaw in a hot water bath (water bath) having a temperature of 35° C. to 38° C. This is because the material thaws quickly while ensuring higher cell recovery rate and cell viability.

[Cell Preparation]

A cell preparation in accordance with an aspect of the present invention (i) contains: cells; and a composition for cryopreservation that contains a fatty acid, and (ii) is in a cryopreserved state. A cell preparation in accordance with another aspect of the present invention (i) contains: cells; and a composition for cryopreservation that contains at least one constituent selected from the group consisting of fatty acids and fatty acid esters, the cells being in the form of a three-dimensional cell mass, and (ii) is in a cryopreserved state. Note that the foregoing descriptions in regard to a composition for cryopreservation in accordance with an aspect of the present invention apply mutatis mutandis to a cell preparation in accordance with an aspect of the present invention.

As used herein, the term “cell preparation” refers to a therapeutic agent that is used as a regenerative medical material in regenerative medicine or the like and that is obtained by making cells into a preparation. The scope of the meaning of the term “cell preparation” includes not only a preparation of cells in their original conditions with no changes in their functions, but also a preparation of cells having undergone culture and proliferation under specific conditions to improve functions such as differentiation ability and immunosuppressive ability.

A cell preparation in accordance with an aspect of the present invention can be obtained suitably by a method of producing a cell preparation in accordance with an aspect of the present invention (described later). Note that, also in a case where step (b) is carried out in a method of producing a cell preparation in accordance with an aspect of the present invention, cells are infiltrated with constituents of a composition for cryopreservation.

[Method of Producing Cell Preparation]

A method of producing a cell preparation in accordance with an aspect of the present invention is a method of producing a cell preparation that contains cells, and the method includes the following steps (a) and (c), the step (c) being carried out after the step (a):

(a) immersing the cells in a cryopreservation medium that contains a fatty acid;

(c) freezing the cells.

A method of producing a cell preparation that contains mesenchymal stem cells, the method including the following steps (a) and (c), the step (c) being carried out after the step (a):

(a) immersing the cells in a cryopreservation medium that contains at least one constituent selected from the group consisting of fatty acids and fatty acid esters;

(b) freezing the cells.

Note that the foregoing descriptions in regard to a method of producing a cryopreserved material in accordance with an aspect of the present invention apply mutatis mutandis to a method of producing a cell preparation in accordance with an aspect of the present invention.

A method of producing a cell preparation in accordance with an aspect of the present invention can be an aspect of a method of producing a cryopreserved material of the present invention.

[Kit for Cell Cryopreservation]

A kit for cell cryopreservation in accordance with an aspect of the present invention is a kit for cryopreserving cells, and includes a fatty acid. A kit for cell cryopreservation in accordance with another aspect of the present invention is a kit for cryopreserving cells in the form of a three-dimensional cell mass, and includes at least one constituent selected from the group consisting of fatty acids and fatty acid esters. Hereinafter, the scope of the meaning of the term “kit for cell cryopreservation” include a “kit for cryopreserving mesenchymal stem cells” and a “kit for cryopreserving cells which are in the form of a three-dimensional cell mass”. For example, a “kit for cell cryopreservation in accordance with an aspect of the present invention” can be an aspect of a kit for cryopreserving cells and can be an aspect of a kit for cryopreserving cells in the form of a three-dimensional cell mass.

According to a kit for cell cryopreservation in accordance with an aspect of the present invention, it is possible to suitably obtain a composition for cryopreservation and a cell preparation in accordance with an aspect of the present invention described earlier. It is also possible to suitably carry out a method of producing a cryopreserved material and a method of producing a cell preparation in accordance with an aspect of the present invention described earlier. Note that the foregoing descriptions in regard to a composition for cryopreservation in accordance with an aspect of the present invention apply mutatis mutandis to a kit for cryopreservation in accordance with an aspect of the present invention. The following description will mainly discuss differences between the matters with regard to the composition and matters with regard to the kit.

A configuration of a kit for cell cryopreservation in accordance with an aspect of the present invention is not particularly limited, provided that the kit includes a fatty acid or at least one constituent selected from the group consisting of fatty acids and fatty acid esters depending on the aspect. The kit may include some other reagent(s) and/or an instrument(s). For example, the kit may include any of the foregoing constituents other than fatty acids and fatty acid esters of a composition for cryopreservation in accordance with an aspect of the present invention. The kit may include a reagent, buffer, and/or the like for stably retaining mesenchymal stem cells, may include a serum-free culture medium for serum-free culture of mesenchymal stem cells, and may include a reagent and/or an instrument for obtaining, from cultured mesenchymal stem cells, a cell mass in the form of a scaffold-free, three-dimensional structure. A kit for cell cryopreservation in accordance with an aspect of the present invention may include a mixture of two or more different reagents in appropriate volumes and/or forms. Alternatively, such reagents in respective different vessels may be provided.

A kit for cell cryopreservation in accordance with an aspect of the present invention may include instructions describing, for example, steps to follow to obtain a composition for cryopreservation. The instructions may be written or printed on paper or some other medium. The instructions may be recorded on magnetic tape or may be stored in an electronic medium such as a disc or a CD-ROM which are readable on a computer or the like.

The present invention is not limited to the foregoing embodiments, but can be altered by a skilled person in the art within the scope of the claims. The present invention also encompasses, in its technical scope, any embodiment derived by combining technical means disclosed in differing embodiments.

[Remarks]

As has been described, a composition in accordance with an aspect of the present invention is preferably arranged such that the cells are mesenchymal stem cells.

A composition for cryopreservation in accordance with an aspect of the present invention is preferably arranged such that: the mesenchymal stem cells are in the form of a three-dimensional, scaffold-free cell mass; and the composition is arranged for cryopreservation of the cell mass.

A composition for cryopreservation in accordance with an aspect of the present invention is preferably arranged such that the cells are in the form of a scaffold-free cell mass.

A composition for cryopreservation in accordance with an aspect of the present invention is preferably arranged such that the cells are obtained by serum-free culture.

A composition for cryopreservation in accordance with an aspect of the present invention is preferably arranged such that the at least one constituent is a fatty acid ester and that the composition further contains a surfactant.

A composition for cryopreservation in accordance with an aspect of the present invention is preferably arranged such that the fatty acid is at least one of linoleic acid and linolenic acid.

A composition for cryopreservation in accordance with an aspect of the present invention is preferably arranged such that the fatty acid ester is a phospholipid.

A composition for cryopreservation in accordance with an aspect of the present invention is preferably arranged such that the phospholipid is phosphatidic acid.

A composition for cryopreservation in accordance with an aspect of the present invention is preferably arranged such that: the fatty acid ester is phosphatidic acid; and the surfactant is Pluronic F-68.

A composition for cryopreservation in accordance with an aspect of the present invention is preferably arranged such that the composition is arranged for cryopreservation at −80° C. or below.

A method of producing a cryopreserved material in accordance with an aspect of the present invention is preferably arranged such that: the method includes step (b) of reducing the amount, relative to the cells, of the cryopreservation medium in which the cells are immersed, the step (b) being carried out after the step (a); and the cells having been subjected to the step (b) are frozen in the step (c).

A method of producing a cryopreserved material in accordance with an aspect of the present invention is preferably arranged such that the step (b) includes bringing the cells into a state in which the cells are not immersed in the cryopreservation medium.

A method of producing a cryopreserved material in accordance with an aspect of the present invention is preferably arranged such the step (c) includes freezing the cells at −80° C. or below.

A method of producing a cell preparation containing cells in accordance with an aspect of the present invention is preferably arranged such that the method includes step (b) of reducing the amount, relative to the cell, of the cryopreservation medium in which the cell is immersed, the step (b) being carried out after the step (a); and the cells having been subjected to the step (b) are frozen in the step (c).

A method of producing a cell preparation containing cells in accordance with an aspect of the present invention is preferably arranged such that the step (b) includes bringing the cells into a state in which the cells are not immersed in the cryopreservation medium.

### EXAMPLES

### <Example 1: Test for Determining Constituent that is Effective for Cryopreservation of Cell Suspension (Experimental Cryopreservation for Elucidating Each Constituent's Effects on Cell Viability)>

For the purpose of determining a constituent(s) effective for cryopreservation of a cell suspension, evaluations were conducted with regard to a cryopreservative effect on MSCs in the form of a test cell suspension, with use of cell cryopreservation media containing different constituents in different amounts. Example 1 was carried out in accordance with the following protocols, unless otherwise noted.

[Protocols]

(Cell Culture)

Primary cultured human synovium-derived MSCs were obtained through the following steps (1) to (4) or were obtained by shredding a tissue into fragments, immersing them in a culture solution (STK (registered trademark) 1) in a culture vessel, and allowing outgrowth of cells from the tissue fragments.

(1) A synovial tissue was taken from a human.

(2) The obtained synovial tissue was washed with phosphate buffered saline (PBS, calcium-free, magnesium-free, PBS(−), Cell Science & Technology Institute, Inc.), then the tissue was added to 10 ml of a 0.4% collagenase solution and blended, and allowed to react at 37° C. for 1 to 4 hours.

(3) The resultant product was subjected to filtering and then centrifugation to recover the synovial tissue.

(4) Primary culture was carried out in a STK (registered trademark) 1 (serum-free culture medium for primary culture of MSCs, available from TWOCELLS Company Limited/DS Pharma Biomedical Co., Ltd., the same applies to the following descriptions), in accordance with the instructions from the manufacturer of the STK 1.

The primary cultured cells obtained in the above manner were subcultured and proliferated in a STK (registered trademark) 2 (serum-free culture medium for passage culture of MSCs, available from DS Pharma Biomedical Co., Ltd., the same applies to the following descriptions) by repeated subculture, in accordance with the instructions from the manufacturer of the STK 2.

[Freezing of Cells]

The MSCs proliferated by repeated subculture were further subjected to plate culture in a STK (registered trademark) 2 culture medium, and, when sub-confluence was reached, the cells were washed once with PBS.

Then, the cells were detached and dissociated into a single cell state with use of TrypLE Select CTS (Thermo Fisher Scientific Inc.), collected in a tube for centrifugation, and diluted with a washing medium (DMEM, Sigma).

Then, the resultant solution was subjected to centrifugation at 1500 rpm at room temperature for 5 minutes, and the cells were thereby pellet down.

These pellet-down MSCs were further suspended in a washing medium to obtain a cell suspension, the cell suspension and a trypan blue solution in respective amounts of 10 μL were mixed, and the number of cells was counted using a OneCell Counter (registered trademark).

On the basis of the count, the cell suspension was separated into aliquots so that “one million cells per tube for centrifugation” would be satisfied, and then the cells were further pellet down in the foregoing manner.

A culture medium for suspension (supernatant) was removed from each tube for centrifugation, and then 1.0 ml aliquots of respective cryopreservation media for use under respective different conditions were dispensed in the respective tubes for centrifugation to obtain suspensions. The kinds and amounts of constituents of each cryopreservation medium are as shown in Tables 1, 2 and 3 below.

The above MSCs, suspended in each cryopreservation medium, were placed in a freezing vial. The freezing vial used here was a cryogenic vial (2 ml, WHEATON).

Then, the freezing vial was transferred to a −80° C. freezer (Panasonic Healthcare Co., Ltd.) and cryopreserved.

[Thawing of Cells]

1. The MSCs (preserved in each freezing vial) which had been cryopreserved for one week in the −80° C. freezer was removed from the freezer.

2. The freezing vial was warmed in a 37° C. hot water bath (water bath) for 2.5 minutes.

3. When it was visually confirmed that a piece of ice had completely thawed, the freezing vial was removed from the water bath.

[Measuring the Number of Cells]

1. The thawed cells were washed once with a washing medium (DMEM, Sigma), and then further suspended in a washing medium to obtain a cell suspension.

2. The cell suspension and a trypan blue solution in respective amounts of 10 μL were mixed in a microtube, and the number of cells was counted using the OneCell Counter (registered trademark) to find cell viability.

[Result 1]

First, experimental cryopreservation of MSCs in the form of a cell suspension was carried out using three different cryopreservation media shown in the following (i) to (iii). The basal medium used in each of the following cryopreservation media is “a mixture of MCDB and DMEM mixed at a ratio of 1:1”. Hereinafter, the cryopreservation media shown in the following (i) to (iii) may be referred to as cryopreservation medium (i), cryopreservation medium (ii), and cryopreservation medium (iii) for short, respectively, according to need.

### (i) Cryopreservation Medium Comprised of Basal Medium

Basal medium

+Albumin (1.25 mg/ml, Millipore, CellPrime rAlbumin: AF-S)+10% DMSO (Wako 031-24051)

(ii) Cryopreservation medium comprised of STK2 (cytokine-free)

Basal medium

+Albumin (1.25 mg/ml, Millipore, CellPrime rAlbumin AF-S)

+Insulin (10 μg/ml, Wako, 090-06481)

+Transferrin (5.5 μg/ml, Wako, 201-18081)

+Ascorbic acid 2-phosphate (VC) (50 μg/ml, SIGMA, A8960)

+Dexamethasone (Dex) (10-8M, SIGMA (Fluka), 31375)

+Na₂SeO₃ (6.7 ng/ml, Wako, 194-10842)

+CD lipid (registered trademark) ( 1/100 diluted, Thermo Fisher Scientific Inc., 11905-031)

+Phosphatidic acid sodium salt (PA) (10 μg/ml, Sigma, P9511)

+Phosphatidylcholine (PC) (10 μg/ml, Sigma P3556)

+L-Glutathione (reduced) (2 μg/ml, Merck Millipore, 104090)

+Lithium chloride (LiCl) (1 mM, Merck Millipore, 105679)

(iii) Cryopreservation Medium Comprised of STK (Registered Trademark) 2

STK (registered trademark) 2+10% DMSO (Wako 031-24051)

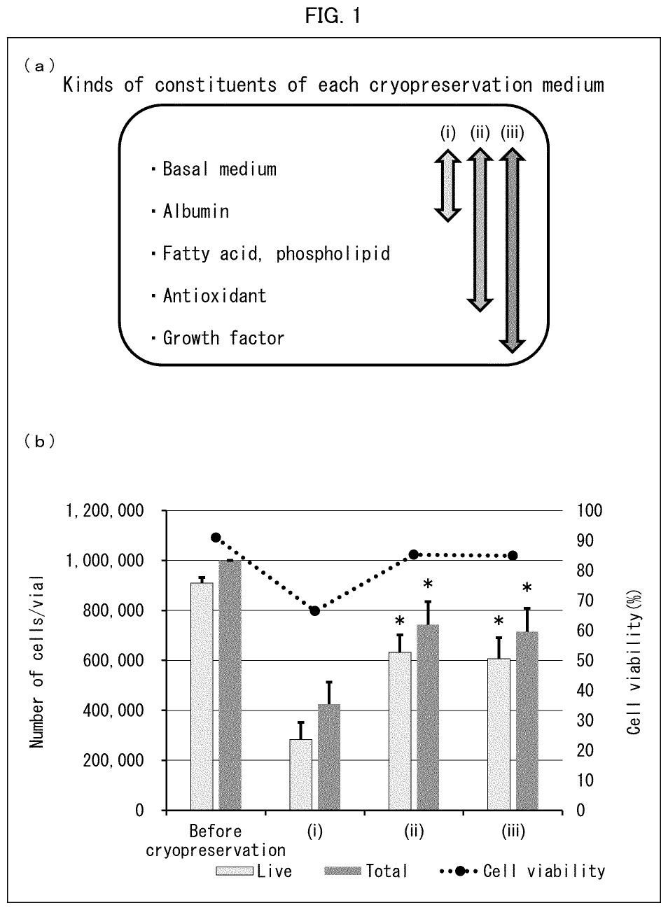

The results are shown in FIG. 1. (a) of FIG. 1 schematically shows the kinds of constituents of each cryopreservation medium for comparison purposes. (b) of FIG. 1 is a bar chart showing the results of experimental cryopreservation. The bars indicated by “Live” in the bar chart each represent “the number of living cells per freezing vial (vial)”, and the bars indicated by “Total” in the bar chart each represent “the total number of cells per freezing vial” (n=3, all the results are expressed in “mean±standard deviation” (mean±SD)). Furthermore, the “Cell viability” means the ratio of “the number of living cells per freezing vial” to “the total number of cells per freezing vial”. Moreover, the results indicated by “Before cryopreservation” are the results obtained in a case where the number of cells which had not been cryopreserved was measured. The other results are those obtained after cryopreservation and thawing.

As shown in (b) of FIG. 1, in a case where a cryopreservation was carried out using the cryopreservation medium (ii) or the cryopreservation medium (iii), the number of MSCs after cryopreservation and thawing was significantly greater than in a case of using the cryopreservation medium (i) (P<0.001). The cell viability was also higher than in the case of the cryopreservation medium (i). Furthermore, no significant difference was found, in terms of the number of cells after cryopreservation and thawing and in terms of cell viability, between the MSCs cryopreserved using the cryopreservation medium (ii) and the MSCs cryopreserved using the cryopreservation medium (iii). The results demonstrated that an aspect of the present invention makes it possible to cryopreserve MSCs in good condition and that cytokine is not essential in the cryopreservation of MSCs.

[Result 2]

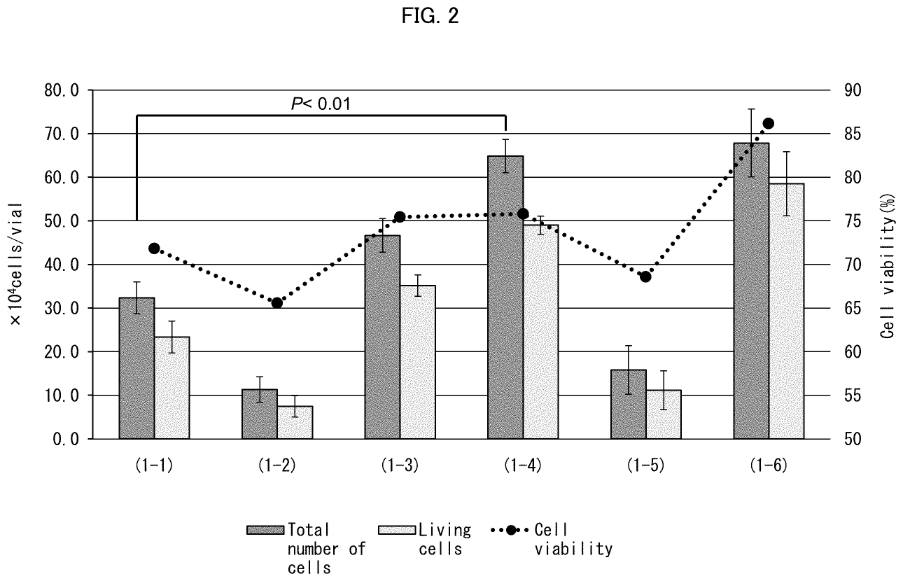

Experimental cryopreservation of MSCs in the form of a cell suspension was carried out with use of the cryopreservation media shown in Table 1. The results are shown in FIG. 2. FIG. 2 is a bar chart showing the results of the experimental cryopreservation of MSCs. The bars indicated by “Total number of cells” in the bar chart each represent “the total number of cells per freezing vial after cryopreservation and thawing”, and the bars indicated by “Living cells” each represent “the number of living cells per freezing vial after cryopreservation and thawing” (n=3, all the results are expressed in “mean±standard deviation” (mean±SD)). Furthermore, the “Cell viability” means the ratio of “the number of living cells per freezing vial” to “the total number of cells per freezing vial”.

Note that the term “basal medium” in Example 1 and the subsequent Examples, such as those shown in Tables, is intended to mean a mixture of MCDB and DMEM, which are basal media, mixed at a ratio of 1:1. Also note that STK2 (cytokine-free) means the cryopreservation medium (ii) described in the foregoing [Result 1] (see (a) of FIG. 1), and that STK (registered trademark) 2 means the cryopreservation medium (iii) described in the foregoing [Result 1] excluding DMSO (see (a) of FIG. 1). STK2 (cytokine-free) may be hereinafter referred to as “STK2(−)” or the like, for short. The kinds of constituents contained in STK2 (cytokine-free) are the same as those of the foregoing STK (registered trademark) 2 culture medium except that STK2 (cytokine-free) contains no cytokine.

TABLE 1
Kinds and amounts of constituents of cryopreservation
media (Final concentration, Manufacturer, Cat No.)

| | |
|---|---|
| (1-1) | 90% (v/v) basal medium + 10% (v/v) DMSO (Wako, |
| | 031-24051) |
| (1-2) | (1-1) + Na₂SeO₃ (Sodium Selenite) (6.7 ng/ml, Wako |
| | 194-10842) |
| (1-3) | (1-1) + Albumin (1.25 mg/ml, Millipore, CellPrime |
| | rAlbumin AF-S) + Insulin (10 μg/ml, Wako, 090- |
| | 06481) + Transferrin (5.5 μg/ml, Wako, 201-18081) + |
| | Ascorbic acid 2-phosphate (VC) (50 μg/ml, |
| | SIGMA, A8960) + Dexamethasone (Dex) (10⁻⁸ M, |
| | SIGMA (Fluka), 31375) + Na₂SeO₃ (6.7 ng/ml, |
| | Wako, 194-10842) |
| (1-4) | (1-1) + CD lipid (registered trademark) (1/100 |
| | diluted, Thermo Fisher Scientific Inc., 11905-031) + |
| | Phosphatidic acid sodium salt (PA) (10 μg/ml, |
| | Sigma, P9511) + Phosphatidylcholine (PC) (10 |
| | μg/ml, Sigma P3556) |
| (1-5) | (1-1) + L-Glutathione (reduced) (2 μg/ml, Merck |
| | Millipore, 104090) + Lithium chloride (LiCl) (1 |
| | mM, Merck Millipore, 105679) |
| (1-6) | 90% (v/v) STK2 (cytokine-free) + 10% (v/v) DMSO |
| | (Wako 031-24051) |

As shown in FIG. 2, the number of cells after cryopreservation and thawing was greater and the cell viability was higher in the conditions in which a cryopreservation medium containing fatty acids, PA, and PC was used (1-4, 1-6) than in the conditions in which a cryopreservation medium containing no fatty acids, PA, or PC was used (other conditions). This demonstrated that fatty acids, PA, and PC are effective for the cryopreservation of MSCs. It was also found that the addition of Na₂SeO₃ alone and the addition of antioxidants “L-Glutathione (reduced)+Lithium chloride (LiCl)” are not effective.

[Result 3]

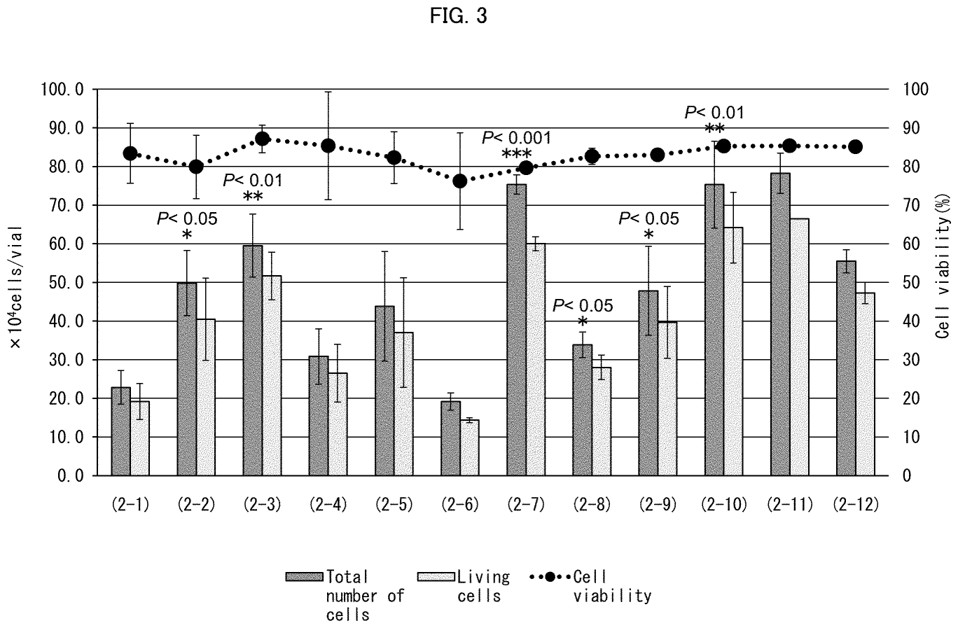

Experimental cryopreservation of MSCs in the form of a cell suspension was carried out using the cryopreservation media shown in Table 2. The results are shown in FIG. 3. FIG. 3 is a bar chart showing the results of the experimental cryopreservation of MSCs. The bars indicated by “Total number of cells” in the bar chart each represent “the total number of cells per freezing vial after cryopreservation and thawing”, and the bars indicated by “Living cells” each represent “the number of living cells per freezing vial after cryopreservation and thawing” (n=3, all the results are expressed in “mean±standard deviation” (mean±SD)). Furthermore, the “Cell viability” means the ratio of “the number of living cells per freezing vial” to “the total number of cells per freezing vial”.

TABLE 2
Kinds and amounts of constituents of cryopreservation media

| | |
|---|---|
| (2-1) | 90% (v/v) basal medium + 10% (v/v) DMSO (Wako, |
| | 031-24051) |
| (2-2) | (2-1) + Albumin (1.25 mg/ml, Millipore, CellPrime |
| | rAlbumin: AF-S) |
| (2-3) | (2-1) + Insulin (10 μg/ml, Wako 090-06481) |
| (2-4) | (2-1) + Transferrin (5.5 μg/ml, Wako 201-18081) |
| (2-5) | (2-1) + Ascorbic acid 2-phosphate (VC) (50 μg/ml, |
| | Sigma, A8960) |
| (2-6) | (2-1) + Dexamethasone (Dex) (10⁻⁸ M, Sigma |
| | (Fluka), 31375) |
| (2-7) | (2-1) + CD lipid (registered trademark) (1/100 |
| | diluted, Thermo Fisher Scientific Inc., 11905-031) |
| (2-8) | (2-1) + Phosphatidic acid sodium salt (PA) (10 |
| | μg/ml, Sigma, P9511) |
| (2-9) | (2-1) + Phosphatidylcholine (PC) (10 μg/ml, Sigma, |
| | P3556) |
| (2-10) | 90% (v/v) STK2(−) (cytokine-free) + 10% (v/v) |
| | DMSO (Wako, 031-24051) |
| (2-11) | (2-1) + CD lipid (registered trademark) (1/100 |
| | diluted, Thermo Fisher Scientific Inc., 11905-031) + |
| | Phosphatidic acid sodium salt (PA) (10 μg/ml, |
| | Sigma, P9511) + Phosphatidylcholine (PC) (10 |
| | μg/ml, Sigma P3556) |
| (2-12) | (2-1) + Albumin (1.25 mg/ml, Millipore CellPrime |
| | rAlbumin, AF-S) + Insulin (10 μg/ml, Wako, 090- |
| | 06481) + Transferrin (5.5 μg/ml, Wako, 201-18081) + |
| | Ascorbic acid 2-phosphate (VC) (50 μg/ml, |
| | SIGMA, A8960) + Dexamethasone (Dex) (10⁻⁸ M, |
| | SIGMA (Fluka), 31375) + Na₂SeO₃ (6.7 ng/ml, |
| | Wako, 194-10842) |

As shown in FIG. 3, the number of cells after cryopreservation and thawing was greater and the cell viability was higher in the conditions in which a cryopreservation medium containing fatty acids was used (2-7, 2-10, 2-11) than in the conditions in which a cryopreservation medium containing no fatty acids was used (other conditions). This demonstrated that fatty acids are effective for cryopreservation of MSCs.

[Result 4]

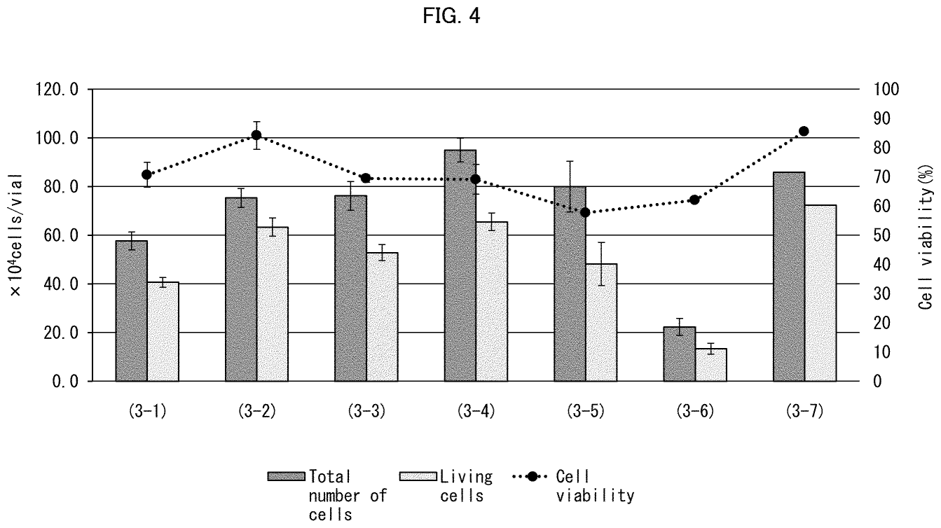

Experimental cryopreservation of MSCs in the form of a cell suspension was carried out using the cryopreservation media shown in Table 3. The results are shown in FIG. 4. FIG. 4 is a bar chart showing the results of the experimental cryopreservation of MSCs. The bars indicated by “Total number of cells” in the bar chart each represent “the total number of cells per freezing vial after cryopreservation and thawing”, and the bars indicated by “Living cells” each represent “the number of living cells per freezing vial after cryopreservation and thawing” (n=3, all the results are expressed in “mean±standard deviation” (mean±SD)). Furthermore, the “Cell viability” means the ratio of “the number of living cells per freezing vial” to “the total number of cells per freezing vial”.

TABLE 3
Kinds and amounts of constituents of cryopreservation media

| | |
|---|---|
| (3-1) | 90% (v/v) basal medium + 10% (v/v) DMSO |
| (3-2) | 90% (v/v) STK2(−) (cytokine-free) + 10% (v/v) DMSO |
| (3-3) | (3-1) + 0.5 × CD lipid (registered trademark) (1/200 |
| | diluted, Thermo Fisher Scientific Inc., 11905-031) |
| (3-4) | (3-1) + 1 × CD lipid (registered trademark) (1/100 |
| | diluted, Thermo Fisher Scientific Inc., 11905-031) |
| (3-5) | (3-1) + 2 × CD lipid (registered trademark) (1/50 diluted, |
| | Thermo Fisher Scientific Inc., 11905-031) |
| (3-6) | (3-1) + Na₂SeO₃ (Sodium Selenite) (6.7 ng/ml, Wako, |
| | 194-10842) |
| (3-7) | (3-1) + Insulin (10 μg/ml, Wako, 090-06481) + Albumin |
| | (1.25 mg/ml, Millipore CellPrime rAlbumin, AF-S) + CD |
| | lipid (1/100 diluted, Thermo Fisher Scientific Inc., |
| | 11905-031) |

As shown in FIG. 4, the number of cells after cryopreservation and thawing was greater and the cell viability was higher in the conditions in which a cryopreservation medium containing fatty acids was used ((3-2) to (3-5), and (3-7)) than in the conditions in which a cryopreservation medium containing no fatty acids were used (other conditions). This demonstrated that fatty acids are effective for cryopreservation of MSCs.

### Example 2: Experimental Cryopreservation Using Scaffold-Free, Three-Dimensional Mass of Mesenchymal Stem Cells

For the purpose of evaluating the effects of a cryopreservation medium in accordance with an aspect of the present invention on a scaffold-free, three-dimensional mass of mesenchymal stem cells, experimental cryopreservation of gMSC (registered trademark) 1 was carried out using the cryopreservation medium (ii) and the cryopreservation medium (iii) stated in [Result 1] of Example 1.

[Protocols (Preparation of gMSC (Registered Trademark) 1, Freezing and Thawing, Cell Count)]

[Preparation of gMSC (Registered Trademark) 1]

Primary cultured human synovium-derived MSCs were obtained through the following steps (1) to (4) or were obtained by shredding a tissue into fragments, immersing them in a culture solution (STK1) in a culture vessel, and allowing outgrowth of cells from the tissue fragments.

(1) Synovial tissue was taken from a human.

(2) The obtained synovial tissue was washed with PBS, then the tissue was added to 10 ml of a 0.4% collagenase solution and blended, and allowed to react at 37° C. for 1 to 4 hours.

(3) The resultant product was subjected to filtering and then centrifugation to recover the synovial tissue.

(4) Primary culture was carried out in a STK (registered trademark) 1 in accordance with the instructions from the manufacturer of the STK 1.

The primary cultured cells obtained in the above manner were subcultured and proliferated in a STK (registered trademark) 2 by repeated subculture, in accordance with the instructions from the manufacturer of the STK 2.

MSCs in a sub-confluent state (5th generation: P5) were washed once with phosphate buffered saline (PBS, calcium-free and magnesium-free, PBS(−), Cell Science & Technology Institute, Inc.), then detached with use of a cell detachment agent TrypLE Select CTS (Thermo Fisher Scientific Inc.), were collected, and suspended in a washing medium (DMEM, Sigma). Then, the cells were transferred to a tube for centrifugation, and subjected to centrifugation at 1500 rpm at room temperature for 5 minutes. The separated single cells were further suspended in a washing medium, and the number of cells was counted using trypan blue staining. The cells were inoculated onto a 6-well plate (SUMITOMO BAKELITE CO., LTD.) containing a STK (registered trademark) 2 at a density of 40×10⁴ cells/cm², and cultured (high-density culture) in an incubator at 37° C. and 5% CO₂ for 7 days. Culture media were replaced three days after the inoculation and five days after the inoculation.

Usually, tissues are mechanically detached from the culture plate seven days after the inoculation, and thereby brought into a state in which a plurality of mesenchymal stem cells aggregate and are crumpled. In this way, a cell mass of gMSC (registered trademark) 1, which is a scaffold-free, three-dimensional structure, is obtained.

[Method of Cryopreserving gMSC (Registered Trademark) 1]

### 1. Materials

(1) Cryopreservation media (manufactured by TWOCELLS Company Limited):

The cryopreservation media (ii) and (iii) stated in [Result 1] of Example 1 were used in respective tests. The kinds and amounts of constituents of these cryopreservation media are described earlier (see (a) of FIG. 1 and the like.)

(2) Cryopreservation vessel: WHEATON cryogenic vial, Cat No.: W985868

(3) Amount of cryopreservation medium used: 1.0 mL per gMSC (registered trademark) 1 cell in each cryogenic vial

2. Preparation and Cryopreservation of gMSC (Registered Trademark) 1

Preparation of gMSC (registered trademark) 1 is carried out in accordance with the descriptions in the foregoing [Preparation of gMSC (registered trademark) 1] section. It is more preferable that the following operation (equilibration) is carried out to allow a cell mass to be infiltrated with a cryopreservation medium.

Equilibration may be carried out “before a culture is processed into the form of gMSC (registered trademark) 1” (see the following (2)) and may be carried out “after a culture is processed into the form of gMSC (registered trademark) 1” (see the following (4)). In Example 2, an example case in which both of the above equilibrations are carried out is discussed. In particular, in Example 2, an equilibration step “before a culture is processed into the form of gMSC (registered trademark) 1” is discussed; therefore, the earlier-described step of preparing gMSC (registered trademark) 1 is briefly discussed as well.

(1) Culture supernatant was entirely aspirated from MSCs cultured at high density on a 6-well plate (day 7).

(2) The 6-well plate was washed twice with 2 mL of PBS(−), 2 mL of a cryopreservation medium was added, and allowed to stand in a safety cabinet at room temperature for 10 minutes.

(3) In the 6-well plate containing the cryopreservation medium, the MSCs cultured at high density were mechanically detached from the culture vessel (i.e., the 6-well plate) with use of a P200 Pipetman (registered trademark) with a chip, and were brought into a crumpled state. In this way, the cells were processed into a three-dimensional gMSC (registered trademark) 1.

(4) Then, the three-dimensional gMSC (registered trademark) 1 was further allowed to stand on the same 6-well plate containing the cryopreservation medium at room temperature for 10 minutes.

(5) The gMSC (registered trademark) 1 was transferred to a freezing vial containing 1 mL of a cryopreservation medium therein, and was allowed to stand in a refrigerator (4° C.) for 10 minutes.

(6) The gMSC (registered trademark) 1 was transferred to a −80° C. freezer and cryopreserved.

[Method of Thawing gMSC (Registered Trademark) 1]

1. The gMSC (registered trademark) 1 (contained in each freezing vial) in a frozen state was removed from the −80° C. freezer.

2. The freezing vial was warmed in a 37° C. hot water bath (water bath) for 2.5 minutes.

3. When it was visually confirmed that the gMSC (registered trademark) 1 in the form of a piece of ice had completely thawed, and the freezing vial was removed from the water bath.

[Method of Measuring the Number of Cells in Thawed gMSC (Registered Trademark) 1]

### 1. Materials

(1) Collagenase-A (Animal Origin Free). Worthington Biochemical Corporation, Cat No.: LS004154

(2) 0.4% trypan blue solution. Thermo Fisher Scientific Inc., Cat No.: 15250

(3) A 560 U(unit)/mL collagenase solution prepared using DMEM was subjected to filtration with use of a 0.45 mm filter (Millipore, Cat No.: SLHV033RS). 2. Method

(1) gMSC (registered trademark) 1 was placed in 1 mL of the collagenase solution in a 15 mL tube for centrifugation.

(2) The solution in the tube is allowed to stand in a CO₂ incubator at 37° C. for 90 minutes. The solution was heated with agitation (vortex) at 30-minute intervals.

(3) At the end of the reaction time, it was confirmed that the gMSC (registered trademark) 1 completely dissociated to a single cell suspension state. Then, the gMSC (registered trademark) 1 was well blended.

(4) The cell suspension and a trypan blue solution in respective amounts of 10 μL were mixed in a microtube, and the number of cells was counted using a OneCell Counter.

[Results of Experiments (the Preparation of gMSC (Registered Trademark) 1, and Cell Count after Cryopreservation and Thawing)]

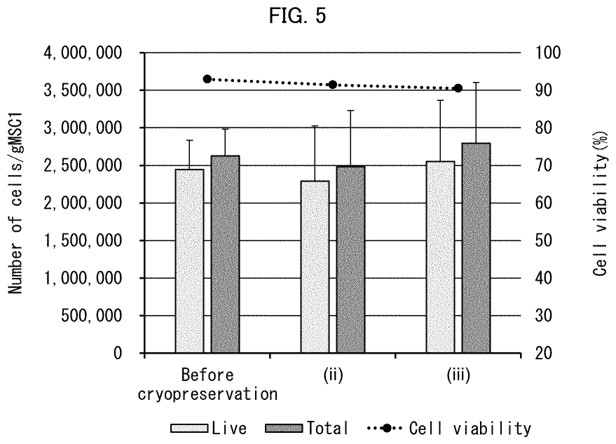

The results of the above experiments are shown in FIG. 5. Specifically, FIG. 5 is a bar chart showing the results of experimental cryopreservation using gMSC (registered trademark) 1. The bars indicated by “Live” in the bar chart each represent “the number of living cells per piece of gMSC (registered trademark) 1”, and the bars indicated by “Total” in the bar chart each represent “the total number of cells per piece of gMSC (registered trademark) 1” (n=3, all the results are expressed in “mean±standard deviation” (mean±SD)). Furthermore, the “Cell viability” means the ratio of “the number of living cells per piece of gMSC (registered trademark) 1” to “the total number of cells per piece of gMSC (registered trademark) 1”. Moreover, the results indicated by “Before cryopreservation” are the results obtained in a case where the number of cells was measured without cryopreservation of gMSC (registered trademark) 1. The other results are those obtained after cryopreservation and thawing.

As described earlier, the cryopreservation media (ii) and (iii) stated in [Result 1] of Example 1 were used in respective tests. The kinds and amounts of constituents of these cryopreservation media have been described earlier (see (a) of FIG. 1 and the like). Each of the cryopreservation media used here contains CD lipid (registered trademark), PA, and PC in the foregoing amounts.

As shown in FIG. 5, the results showed that, with use of each of the cryopreservation media (ii) and (iii), the total number of cells and the number of living cells (cell viability) are good also in cases of a three-dimensional gMSC (registered trademark) 1, similarly to those before freezing. This demonstrated that a cryopreservation medium in accordance with an aspect of the present invention makes it possible to cryopreserve a scaffold-free, three-dimensional mass of mesenchymal stem cells in good condition. Furthermore, a comparison between the cryopreservation medium (ii) and the cryopreservation medium (iii) showed that, also in cases of a scaffold-free, three-dimensional mass of mesenchymal stem cells, the presence/absence of cytokine does not significantly affect the total number of cells and cell viability.

[Checking Osteocyte Differentiation Ability and Adipocyte Differentiation Ability Before and after Cryopreservation]

Next, the abilities to differentiate into osteocytes (bone cells) and adipocytes (adipose cells) were evaluated with use of gMSC (registered trademark) 1 before cryopreservation and with use of gMSC (registered trademark) 1 after cryopreservation and thawing using the cryopreservation medium (ii) or (iii).

(Method of Evaluating Osteocyte Differentiation Ability)

The ability to differentiate into osteocytes (bone cells) was evaluated in the following manner both in cases of gMSC (registered trademark) 1 before cryopreservation and gMSC (registered trademark) 1 after cryopreservation and thawing. Specifically, each gMSC (registered trademark) 1 was treated with collagenase and thereby brought into a single cell state and washed, and then cultured in a STK (registered trademark) 2. When confluence was reached, the culture medium was replaced by a culture medium for osteocyte differentiation (STK (registered trademark) 3 (manufactured by DS Pharma Biomedical Co., Ltd.)), and culture was further carried out. After that, culture media were replaced about once every three days. After 21 days of culture, the cultured gMSC (registered trademark) 1 was stained with alizarin red S (NACALAI TESQUE: 01303-52), and whether osteocyte differentiation was induced or not was checked.

(Method of Evaluating Adipocyte Differentiation Ability)

The ability to differentiate into osteocytes (bone cells) was evaluated in the following manner both in cases of gMSC (registered trademark) 1 before cryopreservation and gMSC (registered trademark) 1 after cryopreservation and thawing. Specifically, each gMSC (registered trademark) 1 was treated with collagenase and thereby brought into a single cell state and washed, and then cultured in a 6-well plate with use of a STK (registered trademark) 2. When confluence was reached, the culture medium was replaced by a culture medium for adipocyte differentiation (DMEM (sigma: D5796), FBS (Hyclone), penicillin-streptomycin (Sigma: P0781), insulin (Wako: 093-06471), dexamethasone (Sigma: D1756), indomethacin (Wako: 097-02471), 3-isobutyl-1-methylxanthine (Calbiochem: 410957)), and culture was carried out for 3 days. After that, the differentiation culture was continued while the adipocyte-differentiation-inducing medium and an adipocyte differentiation maintenance medium (MEM (sigma: D5796), FBS (Hyclone), penicillin-streptomycin (Sigma: P0781), insulin (Wako: 093-06471)) were switched at three-day intervals. After 21 days of culture, the cultured gMSC (registered trademark) 1 was stained with oil red 0 (WAKO: 154-02072), and whether adipocyte differentiation was induced or not was checked.

(Results of Evaluation of Osteocyte Differentiation Ability and Adipocyte Differentiation Ability)

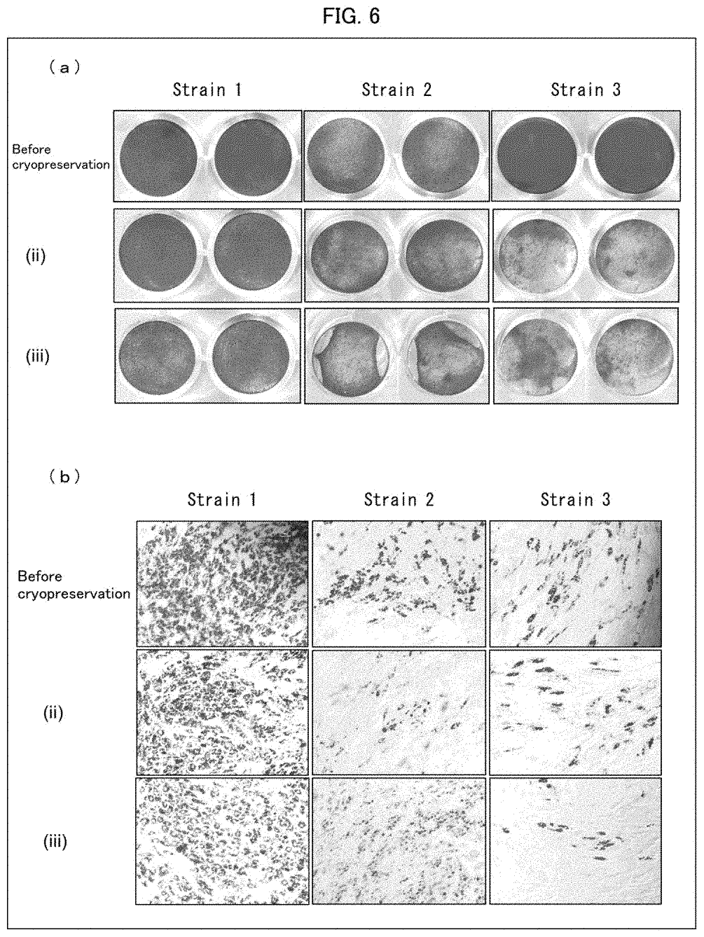

The above experiments were conducted on three strains of gMSC (registered trademark) 1. The results are shown in FIG. 6. FIG. 6 shows the results of experiments to check the osteocyte differentiation ability and adipocyte differentiation ability of cells after cryopreservation and thawing. (a) of FIG. 6 shows the results on osteocyte differentiation ability, and (b) of FIG. 6 shows the results on adipocyte differentiation ability. As shown in FIG. 6, it was confirmed that a scaffold-free, three-dimensional mass of mesenchymal stem cells has good ability to differentiate into osteocytes (bone cells) and adipocytes (adipose cells) even after cryopreservation and thawing, both in cases where freezing was carried out using the cryopreservation medium (ii) and where freezing was carried out using the cryopreservation medium (iii).

[Checking Chondrocyte Differentiation Ability Before and after Cryopreservation]

Next, the ability to differentiate into chondrocytes (cartilage cells) was evaluated with use of gMSC (registered trademark) 1 before cryopreservation and with use of gMSC (registered trademark) 1 after cryopreservation and thawing using the cryopreservation medium (ii) or (iii). Note that, as described below, before inducing chondrocyte differentiation, both the gMSC (registered trademark) 1 before cryopreservation and the gMSC (registered trademark) 1 after cryopreservation and thawing were cut into quarters (a wet weight of about 10 mg to 20 mg each) with use of a sterile knife or scissors.

(Method of Evaluating Chondrocyte Differentiation Ability)

Chondrocyte differentiation is induced in the following manner both in cases of the gMSC (registered trademark) 1 before cryopreservation and the gMSC (registered trademark) 1 after cryopreservation and thawing. Specifically, after the gMSC (registered trademark) 1 was cut into quarters (a wet weight of about 10 mg to 20 mg each), each piece was washed once with a basal medium for chondrocyte differentiation. Then, each piece was transferred to a 15 mL conical tube, an aliquot of a chondrocyte differentiation-inducing medium (high glucose α-MEM that contains 10 ng/ml of TGF-β3, 100 nM of Dexamethasone, 50 μg/ml of L-Ascorbic acid 2-phosphate, 100 μg/ml of Sodium pyruvate, ITS-plus, 6.25 μg/ml of Transferrin, 6.25 μg/ml of Insulin, 6.25 ng/ml of selenate, 5.35 μg/ml of linoleic acid, 1.25 mg/ml of bovine serum albumin (BSA)) was dispensed into the conical tube (1.0 to 1.8 ml/tube), and cultured under the presence of 5% carbon dioxide gas at 37° C. for 28 days. Note that the medium was replaced with the same differentiation-inducing medium at two- to three-day intervals. The quantity of sulfated glycosaminoglycan (glycosaminoglycan: GAG) in the cultured gMSC (registered trademark) 1 was determined with use of a sulfated glycosaminoglycan (glycosaminoglycan: GAG) quantification kit (manufactured by Biocolor). Note that the quantity of GAG was normalized to DNA content of the cells.

(Results of Evaluation of Chondrocyte Differentiation Ability)

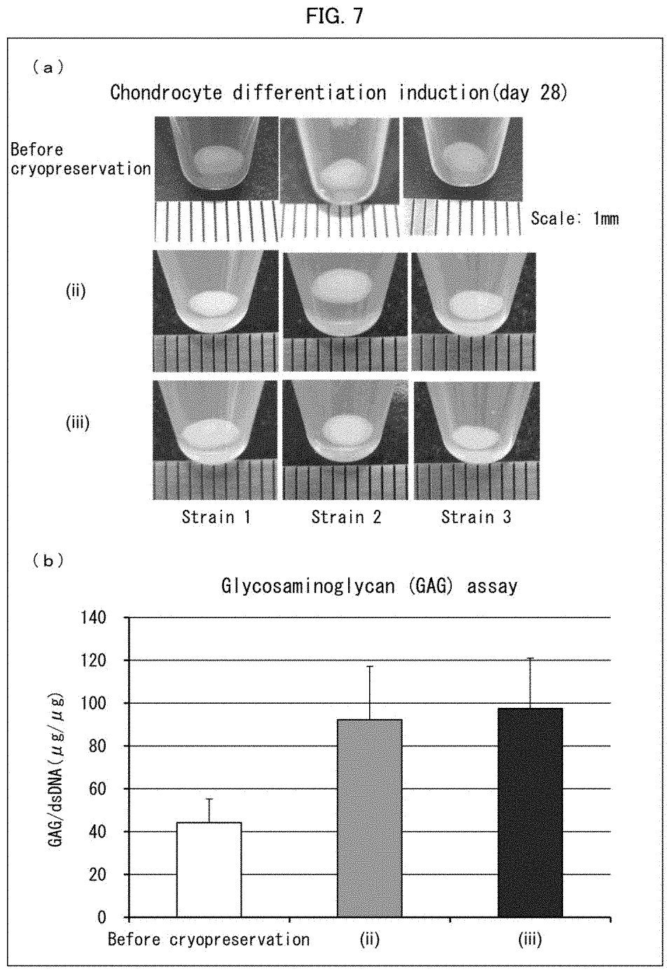

The above operations were conducted on three strains of gMSC (registered trademark) 1. The results are shown in FIG. 7. FIG. 7 shows the results of experiments to check the chondrocyte differentiation ability of cells after cryopreservation and thawing. (a) of FIG. 7 shows photos of samples whose chondrocyte differentiation ability was tested, and (b) of FIG. 7 shows the results of the sulfated glycosaminoglycan (glycosaminoglycan: GAG) assay. As shown in FIG. 7, it was confirmed that a scaffold-free, three-dimensional mass of mesenchymal stem cells have good ability to differentiate into chondrocytes (cartilage cells) even after cryopreservation and thawing, both in cases where freezing was carried out using the cryopreservation medium (ii) and where freezing was carried out using the cryopreservation medium (iii).

[Checking Expression of Cell Surface Antigen Marker Before and after Cryopreservation]

Next, expression of cell surface antigen markers was checked with use of gMSC (registered trademark) 1 before cryopreservation and with use of gMSC (registered trademark) 1 after cryopreservation and thawing using the cryopreservation medium (ii) or (iii). The expression of the cell surface antigen markers was evaluated by Fluorescence Activated Cell Sorting (FACS analysis). A flow cytometer used in the FACS analysis was FACSVERSE (registered trademark) manufactured by BD.

(Preparation of Cell Sample)

(1) A cell suspension was cryopreserved and thawed in the earlier-described manner. The number of cells in the cell suspension and the cell density of the cell suspension were checked, and the cells were subjected to a washing step. Then, an aliquot of five million cells was obtained.

(2) The obtained aliquot of cell suspension was subjected to centrifugation at 1,500 rpm for 5 minutes, and, after finishing the centrifugation, a supernatant was removed substantially entirely.

(3) Cell pellets were suspended and blended in 5 mL of DMEM.

The resultant suspension was subjected to centrifugation at 1,500 rpm for 5 minutes, and, after finishing the centrifugation, a supernatant was removed substantially entirely.

(5) With use of 1.7 mL of 0.5% HSA (human albumin)-containing PBS(−), the obtained cell pellets were suspended and blended. Then, aliquots of 100 μL were dispensed into respective sixteen 2.0 mL tubes.

(FACS Antibody Reaction)

(1) Each antibody was removed from a refrigerated showcase for medicines (4° C.), and added to each of the tubes described above. The amount of the antibody was calculated based on normal concentration (/1,000,000 cells).

(2) A reaction was carried out overnight under protection from light (4° C.).

(3) After the completion of the reaction, centrifugation was carried out at 1,500 rpm for 5 minutes.

(4) After finishing the centrifugation, a supernatant was removed substantially entirely.

(5) 300 μL of 0.5% HSA (human albumin)/PBS was added to each tube to obtain a suspension.

(6) Centrifugation was carried out at 1,500 rpm for 5 minutes, and after finishing the centrifugation, a supernatant was removed substantially entirely.

(7) 300 of 0.5% HSA(human albumin)-containing PBS(−) was added to each tube, and a fluorescent dye (7-Amino-ActinomycinD; 420403 manufactured by Bio Legend) was added to each tube as recommended by the manufacturer to obtain a suspension.

(8) Each sample was passed through a tube with a cell strainer with use of a manually operated pipette (100 to 1000 μL).

(9) An analysis was carried out with FACS Calibur (BD FACSAriaII cell sorter).

TABLE 4

| | Manufacturer | Cat No. |
|---|---|---|
| 1. Cell Only | — | — |
| 2. Mouse IgG1κITCL | BioLegend | 400108 |
| (FITC) | | |
| 3. Anti human CD11b | BioLegend | 301404 |
| (FITC) | | |
| 4. Anti human CD34 | BioLegend | 343504 |
| (FITC) | | |
| 5. Anti human CD44 | BioLegend | 338804 |
| (FITC) | | |
| 6. Anti human CD45 | BioLegend | 304006 |
| (FITC) | | |
| 7. Anti human CD90 | BioLegend | 328108 |
| (FITC) | | |
| 8. Mouse IgG2aκITCL | BioLegend | 400208 |
| (FITC) | | |
| 9. Anti human HLA- | BioLegend | 311404 |
| ABC (FITC) | | |
| 10. Anti human HLA- | BioLegend | 307604 |
| DR (FITC) | | |
| 11. Mouse IgG1κITCL | BioLegend | 400112 |
| (PE) | | |
| 12. Anti human CD13 | BioLegend | 301704 |
| (PE) | | |
| 13. Anti human CD29 | BioLegend | 303004 |
| (PE) | | |
| 14. Anti human CD73 | BioLegend | 344004 |
| (PE) | | |
| 15. Anti human | Miltenyi Biotec | 130-094-941 |
| CD105 (PE) | | |
| 16. Anti human | BioLegend | 343904 |
| CD166 (PE) | | |

(Results of Checking Expression of Cell Surface Antigen Marker Before and after Cryopreservation)

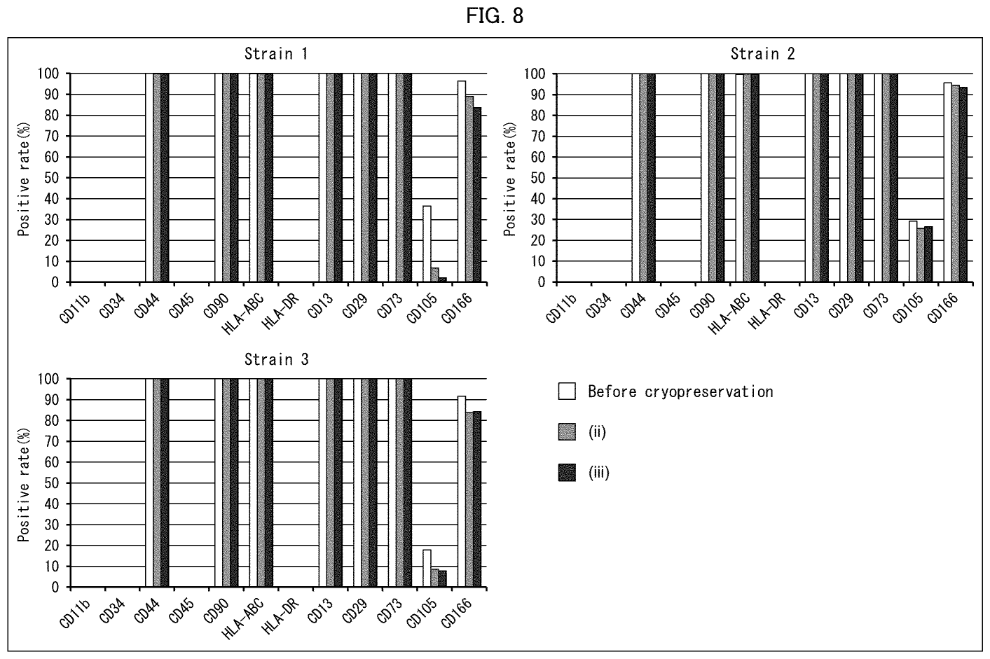

The above analysis was carried out on three strains of gMSC (registered trademark) 1. The results are shown in FIG. 8. FIG. 8 shows the results of experiments to check the expression of cell surface antigen markers after cryopreservation and thawing. As shown in FIG. 8, it was found that a scaffold-free, three-dimensional mass of mesenchymal stem cells shows no or little change in expression profile of cell surface antigen markers between before and after cryopreservation after dissociation of the cell mass, both in cases where cryopreservation and thawing were carried out using the cryopreservation medium (ii) and where cryopreservation and thawing were carried out using the cryopreservation medium (iii).

As has been described, the results of experiments to check osteocyte differentiation ability, adipocyte differentiation ability, chondrocyte differentiation ability, and expression of cell surface antigen markers demonstrated that, according to an aspect of the present invention, even a scaffold-free, three-dimensional mass of mesenchymal stem cells undergoes no or little change in properties of cells even through freezing and thawing.

### Example 3: Experimental Cryopreservation of Scaffold-Free, Three-Dimensional Mass of Mesenchymal Stem Cells, and Effects of the Amount of Cryopreservation Medium During Thawing

In experimental cryopreservation of a scaffold-free, three-dimensional mass of mesenchymal stem cells in which the mass was cryopreserved in accordance with a method of an aspect of the preset invention, the following experiment was carried out to evaluate the effects of the amount of a cryopreservation medium during freezing (thawing).

The [Preparation of gMSC (registered trademark) 1], [Method of thawing gMSC (registered trademark) 1], and [Method of measuring the number of cells in thawed gMSC (registered trademark) 1] were carried out in the same manner as described in Example 2, unless otherwise noted. With regard to [Method of cryopreserving gMSC (registered trademark) 1], either of the two methods shown in Table 5 was carried out. That is, [Freezing with medium] or [Freezing without medium] was carried out.

TABLE 5
Method of cryopreservation

| | |
|---|---|
| Cryopreservation medium was not | Cryopreservation medium was |
| removed | removed |
| (freezing with medium) | (freezing without medium) |

1. PBS(−), 2 ml/well, wash twice
2. Cryopreservation medium 2 ml/well −> allow to stand at room
temperature for 10 minutes
3. Detach cells and allow them to remain in wells
4. Allow to stand at room temperature for 10 minutes
5. Transfer cell mass to freezing vial containing 1 ml of
cryopreservation medium
6. Allow to stand in a refrigerator (4° C.) for 10 minutes

| | |
|---|---|
| 7a. Transfer cell mass to cryogenic | 7b. Transfer cell mass to cryogenic |
| tube containing cryopreservation | tube containing no cryopreservation |
| medium | medium |

8. Transfer it to −80° C. freezer and preserve in the freezer

Note that step 7b in Table 5 is, specifically, an example of the foregoing “step (b)”.

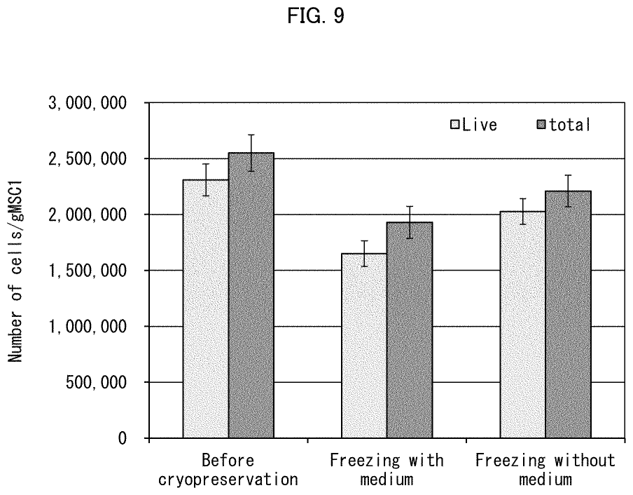

The results of this experiment are shown in FIG. 9. FIG. 9 is a bar chart showing the results of Example 3. The bars indicated by “Live” in the bar chart each represent “the number of living cells per piece of gMSC (registered trademark) 1”, and the bars indicated by “Total” in the bar chart each represent “the total number of cells per piece of gMSC (registered trademark) 1”. Furthermore, the results indicated by “Before cryopreservation” are the results obtained in a case where the number of cells was measured without cryopreservation of gMSC (registered trademark) 1. The other results are those obtained after freezing and thawing.

Each preservation method achieved cryopreservation of mesenchymal stem cells having a scaffold-free, three-dimensional structure with good cell viability. Furthermore, the total number of cells and cell viability were significantly greater in the case of the method by which the cryopreservation medium was removed before cryopreservation (method 7b) than in the case of the method by which the cryopreservation medium was not removed (method 7a). This demonstrated that the “freezing without medium”, which involves “step (b)”, enables cryopreservation that is superior in the total number of cells and cell viability.

### <Example 4: Experiment for Determining Constituent that is Effective for Cryopreservation of Mesenchymal Stem Cells, Especially for Cryopreservation of Scaffold-Free, Three-Dimensional Mass of Mesenchymal Stem Cells: Experimental Cryopreservation for Elucidating Each Constituent's Effects on Cell Viability>

For the purpose of determining a constituent(s) effective for the cryopreservative effect on cells cryopreserved by a method of an aspect of the present invention in greater details, evaluations were conducted with regard to the cryopreservative effect using gMSC (registered trademark) 1 and using cell cryopreservation media containing different kinds of constituents in different amounts.

Note that, in Example 4, [Cell culture], [Preparation of gMSC (registered trademark) 1], [Method of cryopreserving gMSC (registered trademark) 1], and [Method of measuring the number of cells in thawed gMSC (registered trademark) 1] were carried out in the same manner as described in Example 2. The kinds and amounts of constituents of the cryopreservation media evaluated here are as shown in Tables in the following [Result 4-1] to [Result 4-6] sections.

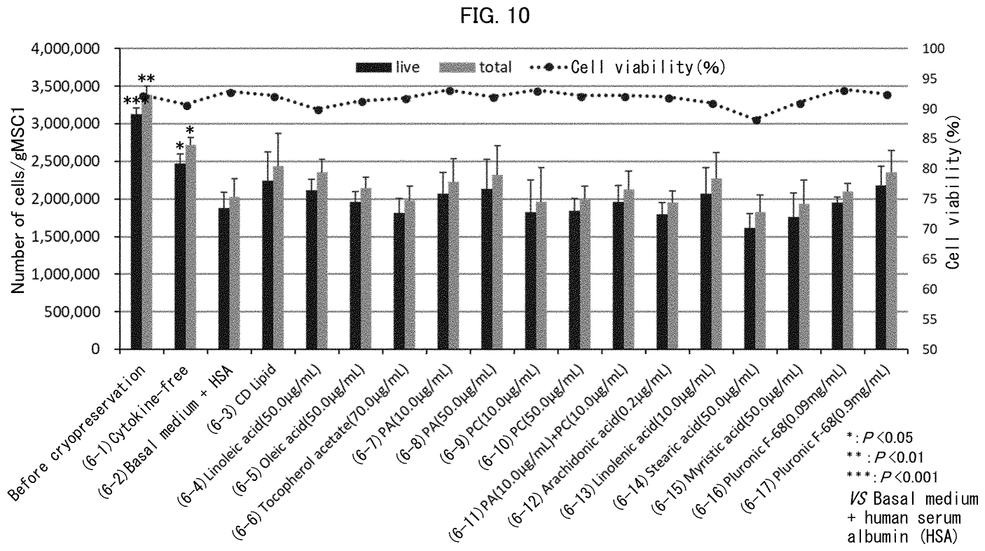

Also note that the experimental results stated in the [Result 4-1] to [Result 4-6] sections are shown in the charts of FIGS. 10 to 15, respectively (described later).

[Result 4-1]

gMSC (registered trademark) 1 was cryopreserved with use of each cryopreservation medium shown in Table 6 under the same conditions as described in Example 2, and thawed. An evaluation was carried out on the number of cells (the number of living cells, and the total number of cells) in the thawed gMSC (registered trademark) 1. The results are shown in FIG. 10. The bars indicated by “Live” in the bar chart each represent “the number of living cells per piece of gMSC (registered trademark) 1”, and the bars indicated by “Total” in the bar chart each represent “the total number of cells per piece of gMSC (registered trademark) 1” (n=3, all the results are expressed in “mean±standard deviation” (mean±SD)). Furthermore, the “Cell viability” means the ratio of “the number of living cells per piece of gMSC (registered trademark) 1” to “the total number of cells per piece of gMSC (registered trademark) 1”. Moreover, the results indicated by “Before cryopreservation” are the results obtained in a case where the number of cells was measured without cryopreservation of gMSC (registered trademark) 1. The other results are those obtained after freezing and thawing.

TABLE 6
Kinds and amounts of constituents of cryopreservation media

| | |
|---|---|
| (6-1) | 90% (v/v) STK2(−) (cytokine-free) + 10% (v/v) DMSO |
| | (Wako 031-24051) |
| (6-2) | 90% (v/v) basal medium + Albumin (1.25 mg/ml, |
| | Millipore CellPrime rAlbumin: AF-S) + 10% (v/v) DMSO |
| | (Wako 031-24051) |
| (6-3) | (6-2) + (CD lipid) (registered trademark) (1/100 diluted, |
| | Thermo Fisher Scientific Inc. 11905-031) |
| (6-4) | (6-2) + Linoleic Acid (50.0 μg/mL, Sigma L5900) |
| (6-5) | (6-2) + Oleic Acid (50.0 μg/mL, Sigma O1257) |
| (6-6) | (6-2) + Tocopherol-Acetate (70.0 μg/mL, Sigma T1157) |
| (6-7) | (6-2) + Phosphatidic acid sodium salt (PA) (10.0 μg/mL, |
| | Sigma P9511) |
| (6-8) | (6-2) + PA (50.0 μg/mL, Sigma P9511) |
| (6-9) | (6-2) + PC (10.0 μg/mL, Sigma P3556) |
| (6-10) | (6-2) + PC (50.0 μg/mL, Sigma P3556) |
| (6-11) | (6-2) + PA (10.0 μg/mL, Sigma P9511) + PC (10.0 μg/mL, |
| | Sigma P3556) |
| (6-12) | (6-2) + Arachidonic Acid (0.2 μg/mL, Sigma A3611) |
| (6-13) | (6-2) + Linolenic Acid (10.0 μg/mL, Sigma L2376) |
| (6-14) | (6-2) + Stearic Acid (50.0 μg/mL, Sigma S4751) |
| (6-15) | (6-2) + Myristic Acid (50.0 μg/mL, Sigma M3128) |
| (6-16) | (6-2) + Pluronic F-68 (0.09 mg/mL, Sigma P5566) |
| (6-17) | (6-2) + Pluronic F-68 (0.9 mg/mL, Sigma P5566) |

The number of cells in thawed gMSC (registered trademark) 1 was significantly greater (P<0.05) in the case where cryopreservation was carried out using the “cryopreservation medium that contains 10% DMSO+STK2 (cytokine-free) (the cryopreservation medium (ii) stated in the results of Example 1)” (6-1) than in the case where cryopreservation was carried out using the “cryopreservation medium composed of 10% DMSO+basal medium+albumin” (6-2) which is a control serving as the basis of comparison. Also, the number of cells in thawed gMSC (registered trademark) 1 was significantly greater in the case of the cryopreservation medium (6-3) (which is the same as the control (6-2) except that CD lipid (registered trademark), i.e., a mixture of fatty acids, is contained) than in the case of the control (6-2).

In addition, in each of the cases where cryopreservation was carried out using the cryopreservation media (6-4), (6-7), (6-8), and (6-13), the number of cells in thawed gMSC (registered trademark) 1 was greater than in the case of the control (6-2). The cryopreservation media (6-4), (6-7), (6-8), and (6-13) were prepared by adding linoleic acid, PA, PA, and linolenic acid, respectively, to the media (6-2) so that the linoleic acid, PA, PA, and linolenic acid concentrations would be 50.0 μg/mL, 10.0 μg/mL, 50.0 μg/mL, and 10.0 μg/mL, respectively.

These results demonstrated the following. The cryopreservation media (6-1) and (6-3) each contain two or more constituents selected from the group consisting of fatty acids and fatty acid esters. Similarly to such cryopreservation media (6-1) and (6-3, cryopreservation media containing a linoleic acid solution, a PA solution, and a linolenic acid solution, respectively, are also effective for the cryopreservation of a scaffold-free, three-dimensional mass of mesenchymal stem cells.

[Result 4-2]

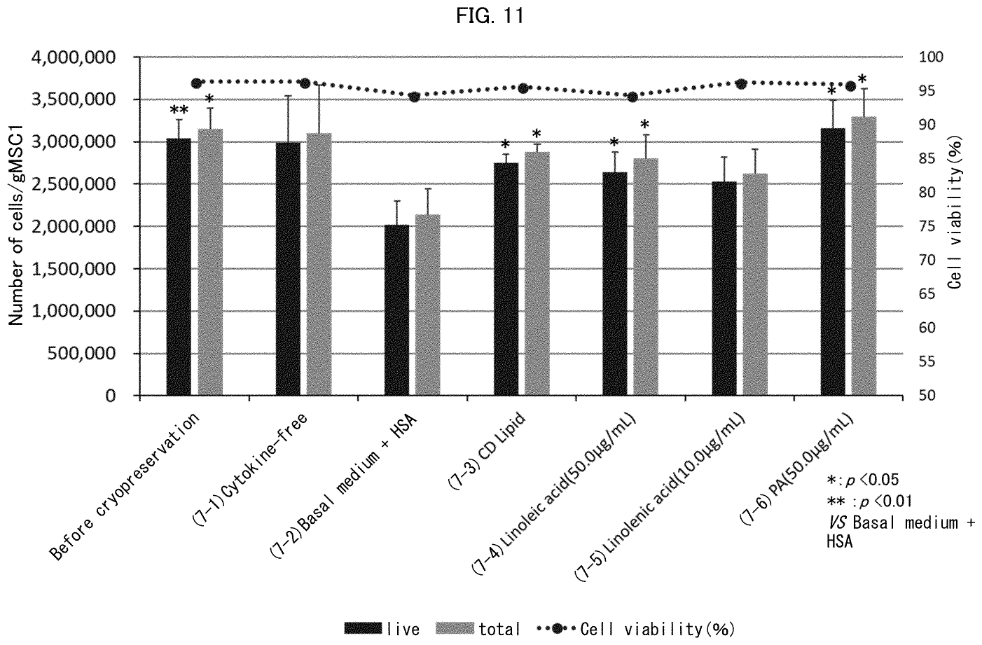

gMSC (registered trademark) 1 was cryopreserved with use of each cryopreservation medium shown in Table 7 under the same conditions as described in Example 2, and thawed. An evaluation was carried out on the number of cells (the number of living cells, and the total number of cells) in the thawed gMSC (registered trademark) 1. The results are shown in FIG. 11. FIG. 11 is a bar chart showing the results of experimental cryopreservation of gMSC (registered trademark) 1 using a cryopreservation medium containing a linoleic acid, a cryopreservation medium containing a linolenic acid, and a cryopreservation medium containing PA. The bars indicated by “Live” in the bar chart each represent “the number of living cells per piece of gMSC (registered trademark) 1”, and the bars indicated by “Total” in the bar chart each represent “the total number of cells per piece of gMSC (registered trademark) 1” (n=3, all the results are expressed in “mean±standard deviation” (mean±SD)). Furthermore, the “Cell viability” means the ratio of “the number of living cells per piece of gMSC (registered trademark) 1” to “the total number of cells per piece of gMSC (registered trademark) 1”. Moreover, the results indicated by “Before cryopreservation” are the results obtained in a case where the number of cells was measured without cryopreservation of gMSC (registered trademark) 1. The other results are those obtained after freezing and thawing.

TABLE 7
Kinds and amounts of constituents of cryopreservation media

| | |
|---|---|
| (7-1) | 90% (v/v) STK2(−) (cytokine-free) + 10% (v/v) DMSO |
| | (Wako 031-24051) |
| (7-2) | 90% (v/v) basal medium + Albumin (1.25 mg/ml, |
| | Millipore CellPrime rAlbumin: AF-S) + 10% (v/v) DMSO |
| | (Wako 031-24051) |
| (7-3) | (7-2) + CD lipid (registered trademark) (1/100 diluted, |
| | Thermo Fisher Scientific Inc. 11905-031) |
| (7-4) | (7-2) + Linoleic Acid (50.0 μg/mL, Sigma L5900) |
| (7-5) | (7-2) + Linolenic Acid (10.0 μg/mL, Sigma L2376) |
| (7-6) | (7-2) + PA (50.0 μg/mL, Sigma P9511) |

In each of the cases of the “cryopreservation medium containing STK2(−) (the cryopreservation medium (ii) of Example 1)” (7-1), the “cryopreservation medium containing CD lipid (registered trademark) (which is a mixture of fatty acids)” (7-3), the “cryopreservation medium containing a linoleic acid solution (linoleic acid is contained in an amount of 50.0 μg/mL)” (7-4), the “cryopreservation medium containing a linolenic acid solution (linolenic acid is contained in an amount of 10.0 μg/mL)” (7-5), and the “cryopreservation medium containing a PA solution (PA is contained in an amount of 50.0 μg/mL)” (7-6), the total number of cells and the number of living cells were greater than in the case of the “cryopreservation medium composed of 10% DMSO+basal medium+albumin” (7-2) which is a control serving as the basis of comparison.

These results demonstrated that the addition of any of the above constituents is effective for cryopreservation of a scaffold-free, three-dimensional mass of mesenchymal stem cells.

[Result 4-3]

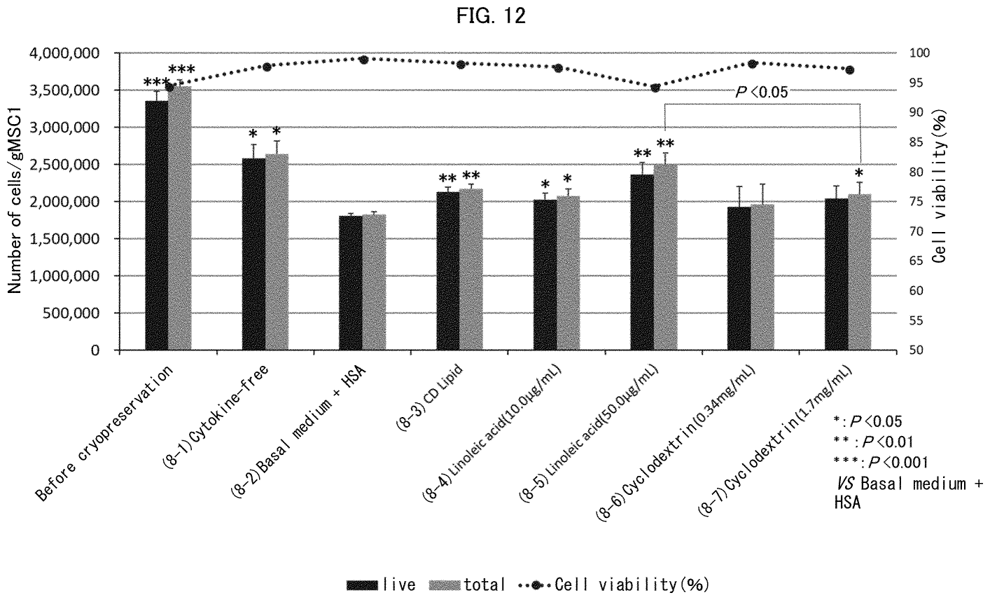

gMSC (registered trademark) 1 was cryopreserved with use of each cryopreservation medium containing the constituents shown in Table 8 in the amounts shown in Table 8 under the same conditions as described in Example 2, and thawed. An evaluation was carried out on the number of cells in the thawed gMSC (registered trademark) 1. The results are shown in FIG. 12.

FIG. 12 is a bar chart showing the results of experimental cryopreservation of gMSC (registered trademark) 1. The bars indicated by “Live” in the bar chart each represent “the number of living cells per piece of gMSC (registered trademark) 1”, and the bars indicated by “Total” in the bar chart each represent “the total number of cells per piece of gMSC (registered trademark) 1” (n=3, all the results are expressed in “mean±standard deviation” (mean±SD)). Furthermore, the “Cell viability” means the ratio of “the number of living cells per piece of gMSC (registered trademark) 1” to “the total number of cells per piece of gMSC (registered trademark) 1”. Moreover, the results indicated by “Before cryopreservation” are the results obtained in a case where the number of cells was measured without cryopreservation of gMSC (registered trademark) 1. The other results are those obtained after freezing and thawing.

TABLE 8
Kinds and amounts of constituents of cryopreservation media

| | |
|---|---|
| (8-1) | 90% (v/v) STK2(−) (cytokine-free) + 10% (v/v) DMSO |
| | (Wako 031-24051) |
| (8-2) | 90% (v/v) basal medium + Albumin (1.25 mg/ml, |
| | Millipore CellPrime rAlbumin: AF-S) + 10% (v/v) DMSO |
| | (Wako 031-24051) |
| (8-3) | (8-2) + CD lipid (registered trademark) (1/100 diluted, |
| | Thermo Fisher Scientific Inc. 11905-031) |
| (8-4) | (8-2) + Linoleic Acid (10.0 μg/mL, Sigma L5900) |
| (8-5) | (8-2) + Linoleic Acid (50.0 μg/mL, Sigma L5900) |
| (8-6) | (8-2) + Methyl-β-cyclodextrin (0.34 mg/mL, Sigma |
| | C4555) |
| (8-7) | (8-2) + Methyl-β-cyclodextrin (1.7 mg/mL, Sigma C4555) |

This experiment was carried out to check what effect a linoleic acid has on cryopreservation of gMSC (registered trademark) 1. In this experiment, with regard to the media (8-4) and (8-5) (each of which is a “cryopreservation medium containing a linoleic acid solution”), methyl-β-cyclodextrin (which is a cyclic oligosaccharide) was pre-added to the linoleic acid solution as a solubilizing agent that helps the linoleic acid dissolve. Specifically, a methyl-β-cyclodextrin was pre-added to a 10 μg/mL linoleic acid solution to achieve a final concentration of 0.34 mg/mL, and a methyl-β-cyclodextrin was pre-added to a 50 μg/mL linoleic acid solution to achieve a final concentration of 1.7 mg/mL.

In view of this, in addition to the above conditions (8-4) and (8-5), also conditions (8-6) and (8-7) were prepared as controls, by adding, to the media (8-2), only methyl-β-cyclodextrin to achieve the same final concentrations as those of the media (8-4) and (8-5), respectively.

Moreover, a “cryopreservation medium composed of 10% DMSO+basal medium+albumin” (these constituents are the same as those of (6-2), (7-2) and the like), which is composed only of the constituents that are contained in all the media (8-4) to (8-7), was also prepared as a control serving as the basis of comparison.

The number of cells in cryopreserved and thawed gMSC (registered trademark) 1 (the total number of cells, the number of living cells) was significantly greater in the case where the cryopreservation medium (8-4) or (8-5) was used than in the case where the cryopreservation medium (8-2) was used (P<0.05 for (8-4) and P<0.01 for (8-5)).

In contrast, in the case where the cryopreservation medium (8-7) was used, i.e., in the case where a solubilizing agent (methyl-β-cyclodextrin) alone was added to achieve a relatively high final concentration (1.7 mg/mL), the total number of cells only is significantly greater (P<0.05) than in the case where the cryopreservation medium (8-2) was used; however, with the addition of methyl-β-cyclodextrin alone, the mean and significance level are both inferior to the condition (8-5) (i.e., the condition in which a linoleic acid is contained and methyl-β-cyclodextrin at the same concentration as (8-7) is contained).

The above results showed the following: a cryopreservation medium containing a linoleic acid solution has a cryopreservative effect, i.e., the effect of cryopreserving mesenchymal stem cells having a scaffold-free, three-dimensional structure with good cell viability; and the cryopreservative effect achieved by a linoleic acid is greater than the cryopreservative effect achieved by methyl-β-cyclodextrin. The above results thus demonstrated that it is the linoleic acid which provides the cryopreservative effect.

[Result 4-4]

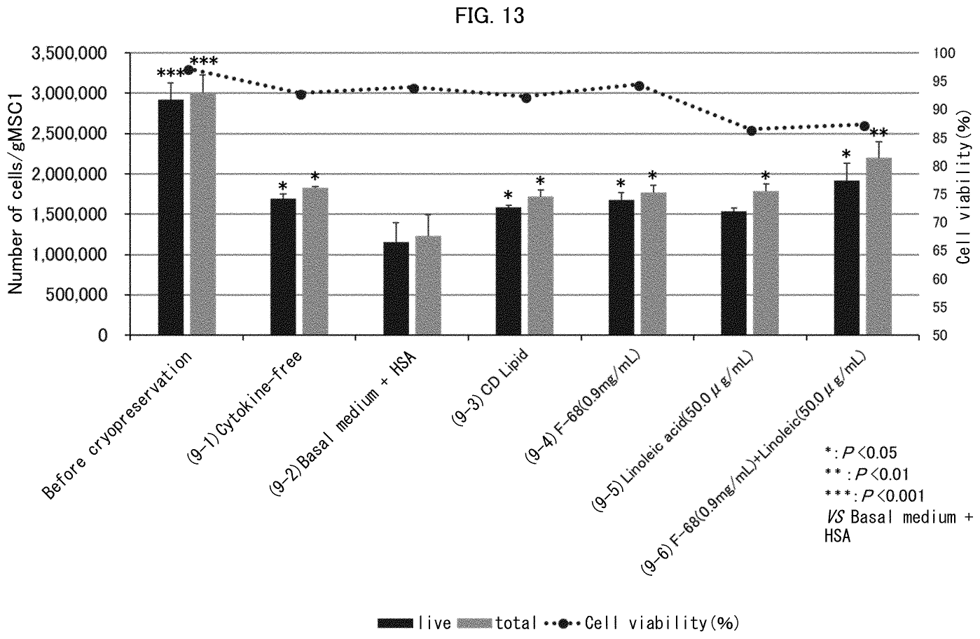

gMSC (registered trademark) 1 was cryopreserved with use of each cryopreservation medium containing the constituents shown in Table 9 in the amounts shown in Table 9 under the same conditions as described in Example 2, and thawed. An evaluation was carried out on the number of cells (the number of living cells and the total number of cells) in the thawed gMSC (registered trademark) 1. The results are shown in FIG. 13.

FIG. 13 is a bar chart showing the results of experimental cryopreservation of gMSC (registered trademark) 1. The bars indicated by “Live” in the bar chart each represent “the number of living cells per piece of gMSC (registered trademark) 1”, and the bars indicated by “Total” in the bar chart each represent “the total number of cells per piece of gMSC (registered trademark) 1” (n=3, all the results are expressed in “mean±standard deviation” (mean±SD)). Furthermore, the “Cell viability” means the ratio of “the number of living cells per piece of gMSC (registered trademark) 1” to “the total number of cells per piece of gMSC (registered trademark) 1”. Moreover, the results indicated by “Before cryopreservation” are the results obtained in a case where the number of cells was measured without cryopreservation of gMSC (registered trademark) 1. The other results are those obtained after freezing and thawing.

TABLE 9
Kinds and amounts of constituents of cryopreservation media

| | |
|---|---|
| (9-1) | 90% (v/v) STK2(−) (cytokine-free) + 10% (v/v) DMSO |
| | (Wako 031-24051) |
| (9-2) | 90% (v/v) basal medium + Albumin (1.25 mg/ml, |
| | Millipore CellPrime rAlbumin: AF-S) + 10% (v/v) DMSO |
| | (Wako 031-24051) |
| (9-3) | (9-2) + CD lipid (registered trademark) (1/100 diluted, |
| | Thermo Fisher Scientific Inc. 11905-031) |
| (9-4) | (9-2) + Pluronic F-68 (0.9 mg/mL, SigmaP5566) |
| (9-5) | (9-2) + Linoleic Acid (50.0 μg/mL, Sigma L5900) |
| (9-6) | (9-2) + Pluronic F-68 (0.9 mg/mL, SigmaP5566) + |
| | Linoleic Acid (50.0 μg/mL, Sigma L5900) |

In this experiment, whether or not a linoleic acid and Pluronic F-68 synergistically affect each other was checked. Note that the linoleic acid solution used in this experiment contains no Pluronic F-68, as with the case of the linoleic acid solution used in [Result 4-3].

The number of cells in cryopreserved and thawed gMSC (registered trademark) 1 was significantly greater in the case where the “cryopreservation medium containing Pluronic F-68 (0.9 mg/mL)” (9-4) or the “cryopreservation medium containing a linoleic acid solution (linoleic acid is contained in an amount of 50.0 μg/mL)” (9-5) was used than in the case where the “cryopreservation medium composed of 10% DMSO+basal medium+albumin” (9-2) (i.e., a control serving as the basis of comparison) was used (P<0.05 for (9-4), P<0.05 for the total number of cells of (9-5)). It was also demonstrated that the use of linoleic acid and Pluronic F-68 in combination (the medium (9-6)) results in a larger number of cells (P<0.01, only the total number of cells).

The above results showed the following: a cryopreservation medium containing a linoleic acid solution and Pluronic F-68 has a cryopreservative effect, i.e., the effect of cryopreserving mesenchymal stem cells having a scaffold-free, three-dimensional structure with good cell viability; and the addition of both of them results in a synergistic effect and greater cryopreservative effect.

[Result 4-5]

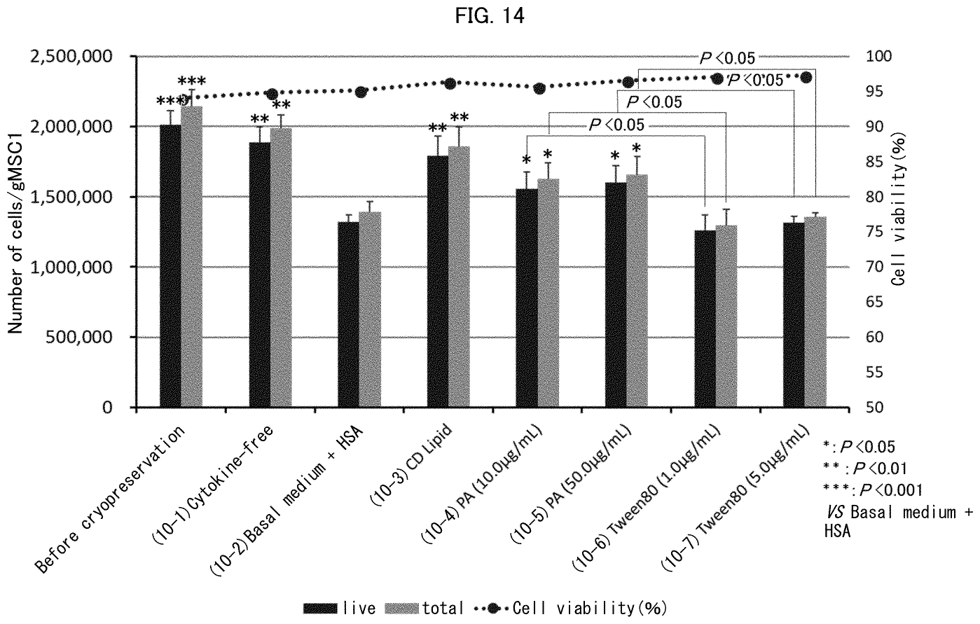

gMSC (registered trademark) 1 was cryopreserved with use of each cryopreservation medium containing the constituents shown in Table 10 in the amounts shown in Table 10 under the conditions described earlier, and thawed. An evaluation was carried out on the number of cells (the number of living cells and the total number of cells) in the thawed gMSC (registered trademark) 1. The results are shown in FIG. 14. FIG. 14 is a bar chart showing the results of experimental cryopreservation of gMSC (registered trademark) 1. The bars indicated by “Live” in the bar chart each represent “the number of living cells per piece of gMSC (registered trademark) 1”, and the bars indicated by “Total” in the bar chart each represent “the total number of cells per piece of gMSC (registered trademark) 1” (n=3, all the results are expressed in “mean±standard deviation” (mean±SD)). Furthermore, the “Cell viability” means the ratio of “the number of living cells per piece of gMSC (registered trademark) 1” to “the total number of cells per piece of gMSC (registered trademark) 1”. Moreover, the results indicated by “Before cryopreservation” are the results obtained in a case where the number of cells was measured without cryopreservation of gMSC (registered trademark) 1. The other results are those obtained after freezing and thawing.

TABLE 10
Kinds and amounts of constituents of cryopreservation media

| | |
|---|---|
| (10-1) | 90% (v/v) STK2(−) (cytokine-free) + 10% (v/v) DMSO |
| | (Wako 031-24051) |
| (10-2) | 90% (v/v) STK basal medium + Albumin (1.25 mg/ml, |
| | Millipore CellPrime rAlbumin: AF-S) + 10% (v/v) DMSO |
| | (Wako 031-24051) |
| (10-3) | (10-2) + CD lipid (registered trademark) (1/100 diluted, |
| | Thermo Fisher Scientific Inc. 11905-031) |
| (10-4) | (10-2) + PA (10.0 μg/mL, Sigma P9511) |
| (10-5) | (10-2) + PA (50.0 μg/mL, Sigma P9511) |
| (10-6) | (10-2) + Tween 80 (1.0 μg/ml, Sigma P6224) |
| (10-7) | (10-2) + Tween 80 (5.0 μg/ml, Sigma P6224) |

This experiment was carried out to check what effect PA has on cryopreservation of gMSC (registered trademark) 1. In this experiment, in each of the “cryopreservation media containing PA solution” (10-4) and (10-5), Tween 80 (surfactant) was added as a solubilizing agent that helps PA emulsify and dissolve. Specifically, Tween 80 was pre-added to a 10 μg/mL PA solution to achieve a final concentration of 1.0 μg/mL, and Tween 80 was pre-added to a 50 μg/mL PA solution to achieve a final concentration of 5.0 μg/mL.

In view of this, in addition to the above conditions (10-4), and (10-5), also conditions (10-6) and (10-7) were also prepared as controls, by adding, to the media (10-2), only Tween 80 to achieve the same final concentrations as those of the media (10-4) and (10-5), respectively.

Moreover, a “cryopreservation medium composed of 10% DMSO+basal medium+albumin” (these constituents are the same as those of (6-2), (7-2) and the like), which is composed only of the constituents that are contained in all the media (10-4) to (10-7), was also prepared as a control (conditions serving as the basis of comparison).

The number of cells in cryopreserved and thawed gMSC (registered trademark) 1 was significantly greater in the case where the “cryopreservation medium containing a PA solution (PA is contained in an amount of 10.0 μg/mL)” (10-4) or the “cryopreservation medium containing a PA solution (PA is contained in an amount of 50.0 μg/mL)” (10-5), in each of which PA and Tween 80 were added, was used than in the case where the “cryopreservation medium composed of 10% DMSO+basal medium+albumin” (10-2) (which is one of the controls, conditions serving as the basis of comparison) was used (P<0.05 for (10-4), P<0.05 for (10-5)). On the contrary, there were no significant effects in the case where Tween 80 alone was added (10-6 and 10-7).

The above results showed the following: a cryopreservation medium containing a PA solution has a cryopreservative effect, i.e., the effect of cryopreserving mesenchymal stem cells having a scaffold-free, three-dimensional structure with good cell viability; and the addition of a solubilizing agent (Tween 80) (which helps PA dissolve) alone does not provide a cryopreservative effect. The results thus demonstrated that PA is effective and that Tween 80 is not effective, and showed that PA has a cryopreservative effect.

[Result 4-6]

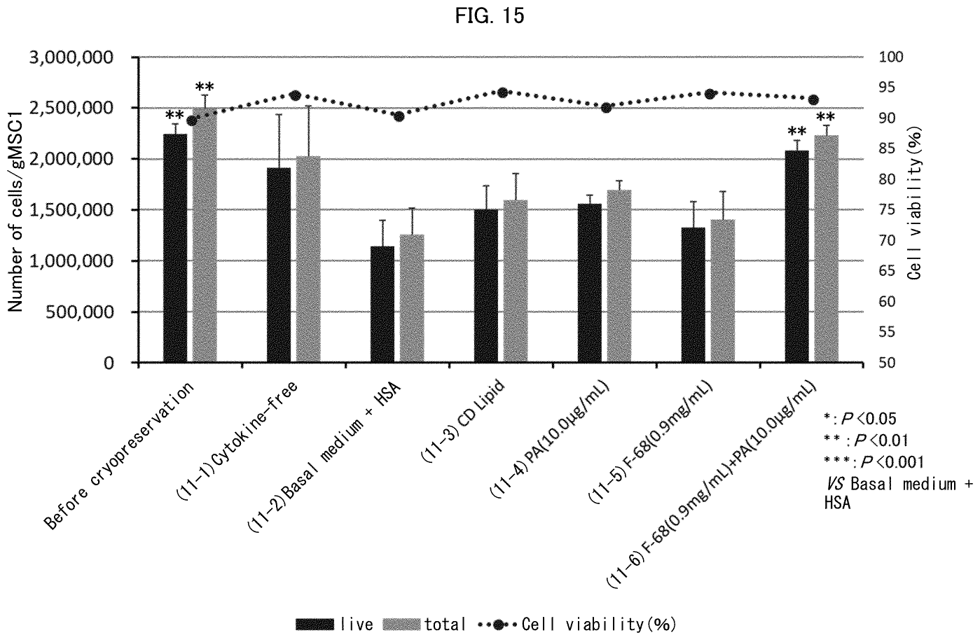

gMSC (registered trademark) 1 was cryopreserved with use of each cryopreservation medium containing the constituents shown in Table 11 in the amounts shown in Table 11 under the same conditions as described in Example 2, and thawed. An evaluation was carried out on the number of cells (the number of living cells and the total number of cells) in the thawed gMSC (registered trademark) 1. The results are shown in FIG. 15. FIG. 15 is a bar chart showing the results of experimental cryopreservation of gMSC (registered trademark) 1. The bars indicated by “Live” in the bar chart each represent “the number of living cells per piece of gMSC (registered trademark) 1”, and the bars indicated by “Total” in the bar chart each represent “the total number of cells per piece of gMSC (registered trademark) 1” (n=3, all the results are expressed in “mean±standard deviation” (mean±SD)). Furthermore, the “Cell viability” means the ratio of “the number of living cells per piece of gMSC (registered trademark) 1” to “the total number of cells per piece of gMSC (registered trademark) 1”. Moreover, the results indicated by “Before cryopreservation” are the results obtained in a case where the number of cells was measured without cryopreservation of gMSC (registered trademark) 1. The other results are those obtained after freezing and thawing.

TABLE 11
Kinds and amounts of constituents of cryopreservation media

| | |
|---|---|
| (11-1) | 90% (v/v) STK2(−) (cytokine-free) + 10% (v/v) DMSO |
| | (Wako 031-24051) |
| (11-2) | 90% (v/v) basal medium + Albumin (1.25 mg/ml, |
| | Millipore CellPrime rAlbumin: AF-S) + 10% (v/v) DMSO |
| | (Wako 031-24051) |
| (11-3) | (11-2) + CD lipid (registered trademark) (1/100 diluted, |
| | Thermo Fisher Scientific Inc. 11905-031) |
| (11-4) | (11-2) + PA (10.0 μg/mL, Sigma P9511) |
| (11-5) | (11-2) + Pluronic F-68 (0.9 mg/mL, Sigma P5566) |
| (11-6) | (11-2) + PA (10.0 μg/mL, Sigma P9511) + Pluronic F-68 |
| | (0.9 mg/mL, SigmaP5566) |

In this experiment, whether or not PA and Pluronic F-68 synergistically affect each other was checked. Note that the PA solution used in this experiment contains no Pluronic F-68, as with the case of the PA solution used in [Result 4-5].

First, the effects of PA alone and the effects of Pluronic F-68 alone were each compared with those of the “cryopreservation medium composed of 10% DMSO+basal medium+albumin” (11-2) which is a control serving as the basis of comparison. As a result, it was found that the number of cells in cryopreserved and thawed gMSC (registered trademark) 1 is greater in the cases of the “cryopreservation medium containing PA solution (PA is contained in an amount of 10.0 μg/mL)” (11-4) and the “cryopreservation medium containing Pluronic F-68 (0.9 mg/mL)” (11-5) than in the case of (11-2).

It was also found that the number of cells in cryopreserved and thawed gMSC (registered trademark) 1 is greater in the case of the medium (11-6) containing PA and Pluronic F-68 in combination than in the case of the media (11-4) and (11-5) in each of which PA or Pluronic F-68 alone is contained. The results thus showed that the addition of PA and Pluronic F-68 in combination resulted in a greater cryopreservative effect (P<0.01).

The above results showed the following: a cryopreservation medium containing PA and Pluronic F-68 has a cryopreservative effect, i.e., the effect of cryopreserving mesenchymal stem cells having a scaffold-free, three-dimensional structure with good cell viability; and the addition of both of them results in a synergistic effect and greater cryopreservative effect.

### INDUSTRIAL APPLICABILITY

Use of the present invention makes it possible to provide mesenchymal-stem-cell-containing graft materials of grater utility value with higher safety. The present invention is therefore suitably usable in regeneration medicine such as graft treatments using mesenchymal stem cells.

1. A composition for cryopreservation of cells,
the composition comprising a fatty acid.

2. The composition as set forth in claim 1, wherein the cells are mesenchymal stem cells.

3. The composition as set forth in claim 2, wherein:
the mesenchymal stem cells are in the form of a three-dimensional, scaffold-free cell mass; and
the composition is arranged for cryopreservation of the cell mass.

4. A composition for cryopreservation of cells,
the cells being in the form of a three-dimensional cell mass, the composition being arranged for cryopreservation of the cell mass,
the composition comprising at least one constituent selected from the group consisting of fatty acids and fatty acid esters.

5. The composition as set forth in claim 4, wherein the cells are mesenchymal stem cells.

6. The composition as set forth in claim 5, wherein the mesenchymal stem cells are in the form of a scaffold-free cell mass.

7. The composition as set forth in claim 2, wherein the mesenchymal stem cells are obtained by serum-free culture.

8. The composition as set forth in claim 4, wherein the at least one constituent is a fatty acid ester,
the composition further comprising a surfactant.

9. The composition as set forth in claim 1, wherein the fatty acid is at least one of linoleic acid and linolenic acid.

10. The composition as set forth in claim 8, wherein the fatty acid ester is a phospholipid.

11. The composition as set forth in claim 10, wherein the phospholipid is phosphatidic acid.

12. The composition as set forth in claim 8, wherein:
the fatty acid ester is phosphatidic acid; and
the surfactant is Pluronic F-68.

13. (canceled)

14. A method of producing a cryopreserved material obtained by freezing cells, the method comprising the following steps (a) and (c), the step (c) being carried out after the step (a):
(a) immersing the cells in a cryopreservation medium that contains a fatty acid;
(c) freezing the cells.

15. A method of producing a cryopreserved material obtained by freezing cells, the cells being in the form of a three-dimensional cell mass,
the method comprising the following steps (a) and (c), the step (c) being carried out after the step (a):
(a) immersing the cells in a cryopreservation medium that contains at least one constituent selected from the group consisting of fatty acids and fatty acid esters;
(c) freezing the cells.

16. The method as set forth in claim 14, wherein:
the method comprises step (b) of reducing an amount, relative to the cells, of the cryopreservation medium in which the cells are immersed, the step (b) being carried out after the step (a); and
the cells having been subjected to the step (b) are frozen in the step (c).

17. The method as set forth in claim 14, wherein the step (b) includes bringing the cells into a state in which the cells are not immersed in the cryopreservation medium.

18. The method as set forth in claim 14, wherein the step (c) includes freezing the cells at −80° C. or below.

19. A cell preparation comprising:
cells; and
a composition for cryopreservation as set forth in claim 1,
the cell preparation being in a cryopreserved state.

20. A cell preparation comprising:
cells; and
a composition for cryopreservation as set forth in claim 4,
the cells being in the form of a three-dimensional cell mass,
the cell preparation being in a cryopreserved state.

21. (canceled)

22. (canceled)

23. (canceled)

24. (canceled)

25. (canceled)

26. (canceled)

27. The composition as set forth in claim 5, wherein the mesenchymal stem cells are obtained by serum-free culture.

28. The composition as set forth in claim 4, wherein the fatty acid is at least one of linoleic acid and linolenic acid.

29. The method as set forth in claim 15, wherein:
the method comprises step (b) of reducing an amount, relative to the cells, of the cryopreservation medium in which the cells are immersed, the step (b) being carried out after the step (a); and
the cells having been subjected to the step (b) are frozen in the step (c).

30. The method as set forth in claim 29, wherein the step (b) includes bringing the cells into a state in which the cells are not immersed in the cryopreservation medium.

31. The method as set forth in claim 15, wherein the step (c) includes freezing the cells at −80° C. or below.
